(19) United States
(12) Patent Application Publication
(10) Pub. No.: US 2012/0238460 A1
(43) Pub. Date: Sep. 20, 2012

(54) RANTES LEVELS AS A DIAGNOSTIC AND THERAPEUTIC FOR ACUTE GRAFT VERSUS HOST DISEASE

(75) Inventors: Ofer Levy, Jamaica Plain, MA (US); Eva Guinan, Newton, MA (US); Eugenie Suter, Chicago, IL (US)

(73) Assignees: DANA-FARBER CANCER INSTITUTE, INC., Boston, MA (US); CHILDREN'S MEDICAL CENTER CORPORATION, Boston, MA (US)

(21) Appl. No.: 12/739,976

(22) PCT Filed: Nov. 10, 2008
(86) PCT No.: PCT/US08/83001

§ 371 Date: Dec. 7, 2011

Related U.S. Application Data
(60) Provisional application No. 60/986,528, filed on Nov. 8, 2007.
(60) Provisional application No. 60/986,517, filed on Nov. 8, 2007.

(51) Int. Cl. C40B 30/04

(52) U.S. Cl. 506/9

(57) ABSTRACT

Disclosed herein are methods for determining the likelihood of a subject to develop Acute graft versus host disease (aGVHD) upon receiving myeloablative allogeneic hematopoietic stem cell transplantation (HSCT). One such method comprises assaying for baseline plasma concentration of RANTES in a sample obtained from the subject, and comparing the baseline plasma concentration of RANTES to a predetermined level. The method may further comprise assaying for day 7 plasma concentration of RANTES in sample obtained from the subject, and comparing the day 7 plasma concentration of RANTES to a predetermined level. Another such method comprises assaying for day 7 plasma concentration of RANTES in a sample obtained from the subject, and comparing the day 7 plasma concentration of RANTES to a predetermined level. Another such method comprises assaying for donor plasma concentration of RANTES in a sample obtained from a donor of the hemtopoietic stem cells, and comparing the donor plasma concentration of RANTES to a predetermined level, wherein a donor plasma concentration of RANTES less than the predetermined level indicates a likelihood of the subject to develop aGVHD upon receiving myeloablative allogeneic HSCT from that donor. Other methods include assaying for day 0, or for day 7, plasma concentration of MCP-1 in a sample obtained from the subject, and comparing the day 0 or day 7, plasma concentration of MCP-1 to a predetermined level.

### RELATED APPLICATIONS

The present application claims priority to U.S. Provisional application 60/986,528 and 60/986,517, filed Nov. 8, 2007, the contents of which are incorporated herein by reference in their entirety.

### FIELD OF THE INVENTION

The present invention relates to the field of transplant biology, specifically the development of graft-versus-host disease upon hematopoietic stem cell transplantation.

### BACKGROUND OF THE INVENTION

Hematopoietic stem cell transplantation (HSCT) is a potentially curative therapy for both benign and malignant lymphohematopoietic diseases and is being explored for a variety of other disorders including autoimmune syndromes and certain solid tumors. The majority of HSCT recipients are leukemia patients who would benefit from treatment with high doses of chemotherapy or total body irradiation. Other conditions often treated with stem cell transplants include sickle-cell disease, myelodysplastic syndrome, neuroblastoma, lymphoma, Ewing's Sarcoma, Desmoplastic small round cell tumor, Hodgkin's disease, marrow failure and multiple myeloma. In addition, non-myeloablative, or so-called “mini transplant,” procedures have recently been developed that require smaller doses of preparative chemo and radiation.

Unfortunately, allogeneic HSCT is frequently complicated by acute graft-versus-host disease (aGVHD), in which donor T cells mount an alloantigen-directed immune response to recipient tissues¹⁻³. aGVHD rates range up to 60% depending upon factors such as recipient age, stem cell source, degree of histocompatibility, and type of aGVHD prophylaxis regimen used⁴. Graft T cell-depletion and immunosuppressive pharmacologic regimens can reduce aGVHD risk, but increase risk of infection and reduce desirable graft-versus-malignancy effects⁵⁻⁶. Greater insight into the mechanisms by which toxicities including aGVHD are initiated and/or exacerbated may define novel opportunities for prophylactic and therapeutic interventions⁷⁻⁹.

Animal models^{10,11} and studies of humans undergoing HSCT^{12,13} suggest that regimen-induced host tissue injury activates the innate immune system, including antigen-presenting cell (APC) production of pro-inflammatory/Th1-polarizing cytokines that initiate aGVHD^{3,8,14}. Myeloablative HSCT results in mucosal barrier injury, increasing translocation of lipopolysaccharide (LPS, or endotoxin) from enteric flora to the peripheral circulation^{12,15,16} and thereby inducing inflammatory sequelae¹⁷. LPS can potently activate APCs via Toll-like receptor-4 (TLR4) to produce inflammatory cytokines. These include tumor necrosis factor-α (TNF-α), production of which has been correlated with aGVHD and early HSCT mortality^{10,18-22}. In mice, limiting cellular responses to LPS limits the occurrence of GVHD during myeloablative HSCT¹¹, suggesting that LPS-induced cytokines (e.g., TNF-α) play important roles in triggering aGVHD. Endotoxemia has been documented in humans undergoing myeloablative HSCT¹², but the role of endotoxemia in development of aGVHD in this clinical setting is unknown.

The ability of humans to detect LPS depends on sequential protein-LPS and protein-protein interactions involving the LPS-binding protein (LBP), membrane (m) and soluble (s) forms of CD14 and MD-2, and TLR4²³⁻²⁵. Sensitivity to LPS can be dampened by changes in expression of these proteins²⁶, as well as plasma lipoproteins²⁷, scavenger receptors that promote LPS clearance²⁸, and competing LPS-binding proteins such as bactericidal/permeability-increasing protein (BPI) that preclude transfer of LPS to CD14 and thus, to MD-2/TLR4²⁹. Neutrophils are the most important source of BPI³⁰ and thus their depletion following myeloablative HSCT conditioning regimens may render recipients especially vulnerable to the pro-inflammatory effects of translocated endotoxin resulting from conditioning-induced mucosal barrier injury. Other endogenous agents, including the CC chemokines RANTES/CCL5 and MCP-1/CCL2, can also modulate host responses to LPS. The platelet-derived RANTES modifies TLR4-dependent responses of monocytes to LPS, increasing monocyte production of the anti-inflammatory cytokine IL-10 and thereby inhibiting LPS-induced production of TNF-α and IL-6³¹. Similarly, MCP-1, whose production is itself induced by LPS³², inhibits LPS-induced TNF-α and IL-12 production, while enhancing production of IL-10³³.

Taken together, these findings suggest a scenario in which the combined effects of myeloablative HSCT conditioning regimes on endotoxin translocation and endogenous mechanisms for regulating host sensitivity to LPS favor the elaboration of cytokines (e.g., TNF-α) that promote the development of aGVHD. While there is evidence linking endotoxemia and LPS-induced immune activation to aGVHD in animal models, little is known about this relationship in humans.

### SUMMARY OF THE INVENTION

One aspect of the invention relates to a method for determining the likelihood of a subject to develop acute graft versus host disease (aGVHD) upon receiving myeloablative allogeneic hematopoietic stem cell transplantation (HSCT). The method comprises assaying for baseline plasma concentration of RANTES in a sample obtained from the subject, and comparing the baseline plasma concentration of RANTES to a predetermined level. A baseline plasma concentration of RANTES less than the predetermined level indicates a likelihood of the subject to develop aGVHD upon receiving myeloablative allogeneic HSCT. In one embodiment, the predetermined level is about 20,000 pg/ml plasma. The method may further comprise assaying for day 7 plasma concentration of RANTES in a sample obtained from the subject, and comparing the day 7 plasma concentration of RANTES to a predetermined level. A day 7 plasma concentration of RANTES less than the predetermined level indicates a likelihood of the subject to develop aGVHD upon receiving HSCT. In the various embodiments, the plasma concentration of RANTES can be determined by a variety of methods, including flow cytometry.

Another aspect of the invention relates to a method for determining the likelihood of a subject to develop aGVHD upon receiving HSCT, comprising assaying for day 7 plasma concentration of RANTES in a sample obtained from the subject, and comparing the day 7 plasma concentration of RANTES to a predetermined level. A day 7 plasma concentration of RANTES less than the predetermined level indicates a likelihood of the subject to develop aGVHD upon receiving myeloablative allogeneic HSCT. In one embodiment, the plasma concentration of RANTES is determined by flow cytometry.

In the various embodiments of the invention described herein, wherein the day 7 plasma concentration is determined, the predetermined levels that the day 7 plasma concentration of RANTES is compared to can be, for example, about 2,000 pg/ml plasma.

Another aspect of the invention relates to a method for determining the likelihood of a subject to develop aGVHD upon receiving HSCT, comprising, assaying for donor plasma concentration of RANTES in a sample obtained from a donor of the hemtopoietic stem cells, and comparing the donor plasma concentration of RANTES determined, to a predetermined level. A donor plasma concentration of RANTES less than the predetermined level indicates a likelihood of the subject to develop aGVHD upon receiving myeloablative allogeneic HSCT from that donor.

In the various embodiments of the invention described herein, where a predetermined level of RANTES is used, the predetermined level may be, for example, about 60,000 pg/ml plasma.

Another aspect of the invention relates to a method for determining the likelihood of a subject to develop aGVHD upon receiving HSCT, comprising assaying for day 0 plasma concentration of MCP-1 in a sample obtained from the subject, and comparing the day 0 plasma concentration of MCP-1 to a predetermined level. A day 0 plasma concentration of MCP-1 less than the predetermined level indicates a likelihood of the subject to develop aGVHD upon receiving HSCT. The method may further comprise determining the day 7 plasma concentration of MCP-1 of the subject, wherein a low day 7 plasma concentration of MCP-1 indicates an increased likelihood of the subject developing aGVHD upon receiving HSCT.

In the various embodiments of the invention described herein, wherein a predetermined level of MCP-1 is used for comparison to day 0 plasma concentrations of MCP-1, the predetermined level may be, for example, about 400 pg/ml plasma.

Another aspect of the invention relates to a method for determining the likelihood of a subject to develop aGVHD upon receiving HSCT, comprising assaying for day 7 plasma concentration of MCP-1 in a sample obtained from the subject, and comparing the day 7 plasma concentration of MCP-1 to a predetermined level. A day 7 plasma concentration of MCP-1 less than the predetermined level indicates a likelihood of the subject to develop aGVHD upon receiving HSCT.

In the various methods described herein, the plasma concentration of MCP-1 can be determined by a variety of methods, for example, flow cytometry.

In the various embodiments of the invention described herein, wherein a predetermined levels is used for comparison to day 7 plasma concentrations of MCP-1, the predetermined level can be, for example, about 700 pg/ml plasma.

Another aspect of the present invention relates to a method for determining the likelihood of a subject to develop an inflammatory response. The method comprises assaying for plasma concentration of MCP-1 and/or RANTES in a sample obtained from the subject, and comparing the plasma concentration MCP-1 and/or RANTES to a predetermined level. A plasma concentration of MCP-1 and/or RANTES less than the predetermined level indicates a likelihood of a subject to develop an inflammatory response. In one embodiment, the subject identified as having a likelihood to develop an inflammatory response is treated prophylactically with anti-inflammatory agents.

### BRIEF DESCRIPTION OF THE DRAWINGS

FIG. 1 is a collection of six graphical representations of data. The data indicates that endotoxemia and febrile neutropenia of myeloablative HSCT are accompanied by deficiency of BPI and RANTES and elevation of IL-6. FIG. 1A: The scattergram of plasma endotoxin levels shows the percentage of positive samples for plasma endotoxin at each time-point. Median values are indicated by a horizontal line. FIG. 1B: Severe neutropenia (mean ANC/μL=69) was observed at D7, coinciding with peak incidence (%) of fever. FIG. 1C: Plasma BPI levels fell >1 log (p<0.0001, N=30) by D7, correlating with ANC, shown in FIG. 1D (Spearman r=0.69; p<0.0001). FIG. 1E: Mean+SEM plasma RANTES, exhibited a nadir on D7 (p<0.0001, N=25) and remained significantly depressed through D14 (p<0.0001). FIG. 1(F) Plasma IL-6 peaked on D7 (p<0.0001, N=25). Data represent mean±SEM, comparisons by Wilcoxon signed rank test. *p<0.05, **p<0.01, ***p<0.001. Undetectable values are plotted at one-half the lower limit of detection.

FIG. 2 is a collection of three line graphs representing data which indicates that endotoxin-modulating plasma proteins LBP and sCD14 rise during myeloblative HSCT. FIG. 2A: LBP was elevated on D7 (p=0.05, N=30) and D14 (p=0.07), FIG. 2B: sCD14 was elevated at D21 (p<0.05), and D28 (p<0.01; N=29-30), and FIG. 2C: sMD-2 (N=10-11) did not significantly change. Data represent mean±SEM, comparisons by Wilcoxon signed rank test.

FIG. 3 is a collection of three line graphs representing data that indicates that monocyte endotoxin receptor components mCD14 and TLR4 are significantly modulated at D0. Measurement of monocyte surface expression by flow cytometry. FIG. 3A shows mCD14 exhibited a nadir D0 (p<0.05, one-sided; N=10). FIG. 3B shows that TLR4 expression peaked at D0 (p<0.05, one-sided; N=9), whereas FIG. 3C shows TLR2 expression did not significantly vary. Data represent mean MFI (mCD14) or binding index (TLR4 and 2)±SEM, comparisons by Wilcoxon signed rank test.

FIG. 4 contains two graphical representations of data which indicate a reciprocal relationship of plasma MCP-1 concentrations and spontaneous generation of TNF-α in whole blood in vitro. FIG. 4A shows MCP-1 was elevated from D0 to D14 (D0, p<0.0001; D7, p<0.0001; D14, p<0.0001, N=25). FIG. 4B shows MCP-1 and spontaneous TNF-α production were negatively correlated (Spearman r=−0.56, p<0.0001). Samples containing no detectable TNF-α are plotted as one-half the lower limit of detection.

FIG. 5 contains three graphical representations of data which indicate that low plasma BPI/LBP ratio, RANTES and MCP-1 concentrations correlate with subsequent aGVHD. Comparison of plasma concentrations of proteins that modulate LPS activity in patients who did or did not develop aGVHD (grade≧1) demonstrates that patients who developed aGVHD had a lower ratio of plasma BPI/LBP concentrations at baseline (FIG. 5A, aGVHD N=12/no aGVHD N=18), lower plasma MCP-1 concentrations at days D0 and D7 (FIG. 5B; aGVHD N=10/no aGVHD N=15), and lower plasma RANTES concentrations at baseline and D7 (FIG. 5(C); aGVHD N=10/no aGVHD N=15). Data represent mean±SEM. P values were determined by two-sided Mann-Whitney test with values ≦0.05 indicated in bold.

FIG. 6 is a graphical representation of data that indicates depletion of RANTES during myeloablative HSCT. Comparison of plasma concentration of RANTES in donors and in HSCT recipients. Peripheral blood was obtained from donors at the time of donation and patients at the indicated time points. Plasma was prepared and analyzed for RANTES (Regulated upon Activation Normal T Cell Expressed and Secreted).

FIG. 7 is a graphical representation of data that indicates low plasma RANTES concentrations in patients and donors correlate with subsequent aGVHD. Comparison of plasma concentrations of proteins that modulate LPS activity in patients who did or did not develop aGVHD (grade≧1) demonstrates that patients who developed aGVHD had a lower plasma RANTES concentrations at baseline and also at D0. Donors to patients of myeloablative allogeneic HSCT who developed aGVHD had a lower plasma RANTES concentration at the time of donation.

### DETAILED DESCRIPTION OF THE INVENTION

Aspects of the present invention are based on findings from a study of hematopoietic stem cell transplant recipients. The study monitored various factors in the plasma of the recipients and tracked whether they developed acute graft-versus-host disease (aGVHD). Allogeneic hematopoietic stem cell transplant recipients were assayed for the presence of endotoxin, a variety of LPS-modulating proteins, and chemokines. Patients who developed aGVHD were observed to have lower levels of plasma RANTES (Regulated upon Activation Normal T Cell Expressed and Secreted) at specific times in the transplant process, as compared to levels of plasma RANTES of similarly treated patients who did not develop aGVHD. Patients who developed aGVHD were also observed to have lower levels of plasma MCP-1 at specific times in the transplant process, as compared to levels of plasma MCP-1 of similarly treated patients who did not develop aGVHD. These observations indicate that the levels of these proteins in a patient at critical time points in the transplant process, indicate a propensity of the patient to develop aGVHD. These results also indicate that replenishment of deficient endotoxin antagonists can reduce toxicities associated with myeloablative HSCT, lessening the severity of aGVHD and potentially preventing its development. Although these experiments were performed on patients who received myeloablative allogeneic stem cell transplantation (HSCT), the findings also apply to other types of HSCT (e.g. partial myeloablative and syngeneic HSCT). They may also find application in analysis/diagnosis of other tissue type transplantations known to elicit aGVHD.

As used herein, the term patient or subject is used to describe an individual who receives, or is a candidate for receipt of transplant (e.g. myeloablative, allogeneic HSCT).

As used herein, the term donor is used to describe an individual or subject who donates or is a candidate for donation of tissue (e.g. hematopoietic stem cells for use in HSCT) to a recipient subject.

As used herein, the term likelihood, when used in conjunction with plasma RANTES concentration, refers to an increased propensity of a subject to develop aGVHD or one or more disease symptoms of aGVHD, as compared to subjects whose plasma RANTES concentration is above the predetermined level at the indicated time points. A subject with levels below the predetermined levels described herein, or otherwise determined by the skilled practitioner, have an increased susceptibility to aGVHD development. As used herein, the term likelihood, when used in conjunction with MCP-1 levels, refers to an increased propensity of a subject to develop aGVHD or one or more disease symptoms of aGVHD, as compared to subjects whose MCP-1 are above the predetermined level at the indicated time points. A subject with levels below the predetermined levels described herein, or otherwise determined by the skilled practitioner, have an increased susceptibility to aGVHD development.

As used herein, the term transplant refers to the grafting or introduction of tissue or cells obtained from one individual (the donor) into or onto the body of another individual (the recipient). Any tissue can be transplanted. Examples of tissues commonly transplanted are bone marrow, hematopoetic stem cells, organs such as liver, heart, skin, bladder, lung, kidney, cornea, pancreas, pancreatic islets, brain tissue, bone, intestine, and heamatopoietic cells. The tissue or cell may optionally undergo treatment ex vivo prior to introduction to the recipient.

Both statistically significant and nearly statistically significant results as determined from relevant populations of donors and subjects are considered useful for predicting the likelihood of, and/or identifying a propensity for development of aGVHD in an individual subject. Both statistically significant and nearly significant differences between levels in a patient or donor and the threshold levels identified herein, are considered useful for predicting the likelihood of the recipient patient to develop aGVHD.

One aspect of the present invention relates to a method for determining the likelihood of a subject to develop aGVHD following tissue transplant such as myeloablative allogeneic HSCT. The method involves assaying for the plasma concentration of RANTES in the subject at baseline, herein referred to as the baseline plasma concentration or baseline plasma RANTES concentrations. Baseline refers to the state of the subject prior to transplant (e.g. HSCT) and also prior to any conditioning of the subject for/prior to the transplant. The baseline plasma concentration of RANTES is then compared to a predetermined level of RANTES (at baseline), and a determination of the subject's RANTES levels as below the predetermined level indicates a likelihood of the subject to develop aGVHD upon receiving a transplant such as myeloablative allogeneic HSCT.

Specific threshold levels of RANTES at baseline, which indicate likelihood of a subject to develop aGVHD, have been identified by the analysis detailed in the Examples section below. A subject having a baseline plasma concentration of RANTES which is below such a threshold level is identified as having an increased susceptibility to aGVHD. Applicants have determined one such threshold level of plasma RANTES at baseline, being about 20,000 pg/ml as determined by the methods described herein.

The determination of RANTES plasma levels at baseline may optionally further include making a determination of the plasma concentration of RANTES in the subject at day 7 of the transplant. Plasma concentration of RANTES at day 7 of myeloablative allogeneic HSCT have also been identified as indicative of a subject's susceptibility to aGVHD. As such, determination of the plasma RANTES of a subject at day 7, herein referred to as the day 7 plasma concentration below a predetermined threshold level for day 7 RANTES, indicates a likelihood of a subject to develop aGVHD. The determination at day 7 used in combination with the determination at baseline, will provide a further indication of whether a subject is likely to develop aGVHD. Use of this diagnostic test at the latter time point can be used to gage the effectiveness of aGVHD therapeutics (treatment or prevention).

The determination at day 7, in the absence of determination of baseline RANTES, also provides an indication of the likelihood of a subject to develop aGVHD. As such, one aspect of the present invention relates to a method for determining the likelihood of a subject to develop acute GVHD upon receiving transplant (e.g. myeloablative allogeneic HSCT), by assaying for the plasma concentration of RANTES in the subject at day 7. Day 7 refers to the seventh day post actual introduction of tissue or cells (e.g. HSCT). The day 7 plasma concentration of RANTES is then compared to a predetermined level of RANTES (at day 7), with a determination of the subject's RANTES levels as below the predetermined level indicating a likelihood of the subject to develop aGVHD upon receiving the transplant.

Specific threshold levels of RANTES plasma concentration at day 7, below which would indicate likelihood of a subject to develop aGVHD, have been identified by the analysis detailed in the Examples section below. A subject having a day 7 plasma concentration of RANTES which is below such a threshold level is identified as having an increased susceptibility to aGVHD. Applicants have determined one such threshold level of plasma RANTES at day 7, being about 2000 pg/ml as determined by the methods described herein.

The amount of RANTES in the plasma of a donor of hematopoietic stem cells for myeloablative allogeneic HSCT has also been shown to correlate with the likelihood of a subject (the recipient of the donor cells) to develop aGVHD upon receiving HSCT from that donor. As such, aspects of the present invention relate to a method for determining the likelihood of a subject to develop aGVHD upon receiving a transplant (e.g. myeloablative allogeneic HSCT), by assaying for donor plasma concentration of RANTES in a sample obtained from a donor of the tissue or cells (e.g. hematopoietic stem cells), and comparing the determined donor plasma concentration of RANTES to a predetermined level. A donor plasma concentration of RANTES which is less than the predetermined level indicates a likelihood of the subject to develop aGVHD upon receiving HSCT from that donor.

The amount of RANTES in the plasma of a donor, also referred to herein as donor plasma RANTES, is determined by analogous method as those described herein for determination of RANTES in the plasma of a recipient subject. Specific threshold levels of donor plasma RANTES, below which would indicate a likelihood of a recipient subject to develop aGVHD, have been identified by the analysis detailed in the Examples section below. A donor having a plasma concentration of RANTES which is below such a threshold level is identified as conferring an increased susceptibility to aGVHD to a recipient. Applicants have determined one such threshold level of donor plasma RANTES as being about 60,000 pg/ml as determined by the methods described herein.

This method may optionally include assessment of baseline plasma RANTES in the recipient subject, and/or assessment of day 7 plasma RANTES in a recipient subject, as described herein. Combination of these assessments will provide even more statistically significant indications of a likelihood of a subject to develop aGVHD. The various levels of assessment, using one or more combined methods of the present invention, will provide the physician with a spectrum of useful information which finds application in circumstances of HSCT which involve prognosis and/or diagnosis and/or treatment regimen.

The methods of determining the likelihood of a subject to develop acute GVHD described herein, can be used, for example, in analysis of effectiveness of prevention and/or treatment regimens, some examples of which are described herein.

The respective predetermined levels RANTES, also referred to as threshold levels, can be determined for the relevant time points by the skilled artisan through studies such as the one detailed in the Examples section below. More specifically, they can be determined through surveyance of a group of individuals who receive a transplant of the relevant organ/tissue type to the subject, (e.g. myeloablative allogeneic HSCT), with analysis of plasma levels of RANTES at specific times prior to and throughout the transplant process (e.g. baseline, day 0, day 7, day 14, day 21, etc.). This is coupled to determination of whether and which individuals develop aGVHD, with correlation of the RANTES levels to the development, or lack of development, of the aGVHD. Predetermined levels are arrived at by identification of statistically significant, or nearly statistically significant correlations of levels of indicator factors with disease development.

For methods which involve donor levels of RANTES, predetermined levels for donor plasma RANTES can be determined by the skilled artisan through studies such as those set forth below. For example, a population of donors is analyzed for plasma levels of RANTES, and the donee subjects are then followed for development of aGVHD. RANTES levels in donors from which donees develop aGVHD are correlated to establish a predetermined level of plasma RANTES of the donor which correlates with an increased likelihood of the donee subject to develop aGVHD.

Another aspect of the present invention relates to a method for determining the likelihood of a subject to develop aGVHD following tissue transplant such as myeloablative allogeneic HSCT. The method involves assaying for the plasma concentration of MCP-1 in the subject at day 0, herein referred to as the day 0 plasma concentration or day 0 plasma MCP-1 concentrations. Day 0 refers to the state of the subject just prior to transplant (e.g. HSCT) or on the day of transplant. The day 0 plasma concentration of MCP-1 is then compared to a predetermined level of MCP-1 (at day 0), and a determination of the subject's MCP-1 levels as below the predetermined level indicates a likelihood of the subject to develop aGVHD upon receiving a transplant such as myeloablative allogeneic HSCT.

Specific threshold levels of MCP-1 at day 0, which indicate likelihood of a subject to develop aGVHD, have been identified by the analysis detailed in the Examples section below. A subject having a day 0 plasma concentration of MCP-1 which is below such a threshold level is identified as having an increased susceptibility to aGVHD. Applicants have determined one such threshold level of plasma MCP-1 at day 0, being about 400 pg/ml as determined by the methods described herein.

The determination of MCP-1 plasma levels at day 0 may optionally further include making a determination of the plasma concentration of MCP-1in the subject at day 7 of the transplant. Plasma concentration of MCP-1 at day 7 of myeloablative allogeneic HSCT have also been identified as indicative of a subject's susceptibility to aGVHD. As such, determination of the plasma MCP-1 of a subject at day 7, herein referred to as the day 7 plasma concentration below a predetermined threshold level for day 7 MCP-1, indicates a likelihood of a subject to develop aGVHD. The determination at day 7 used in combination with the determination at day 0, will provide a further indication of whether a subject is likely to develop aGVHD. Use of this diagnostic test at the latter time point can be used to gage the effectiveness of aGVHD therapeutics (treatment or prevention).

The determination at day 7, in the absence of determination of day 0 MCP-1, also provides an indication of the likelihood of a subject to develop aGVHD. As such, one aspect of the present invention relates to a method for determining the likelihood of a subject to develop acute GVHD upon receiving transplant (e.g. myeloablative allogeneic HSCT), by assaying for the plasma concentration of MCP-1 in the subject at day 7. Day 7 refers to the seventh day post actual introduction of tissue or cells (e.g. HSCT). The day 7 plasma concentration of MCP-1 is then compared to a predetermined level of MCP-1 (at day 7), with a determination of the subject's MCP-1 levels as below the predetermined level indicating a likelihood of the subject to develop aGVHD upon receiving the transplant.

Specific threshold levels of MCP-1 plasma concentration at day 7, below which would indicate likelihood of a subject to develop aGVHD, have been identified by the analysis detailed in the Examples section below. A subject having a day 7 plasma concentration of MCP-1 which is below such a threshold level is identified as having an increased susceptibility to aGVHD. Applicants have determined one such threshold level of plasma MCP-1 at day 7, being about 700 pg/ml as determined by the methods described herein.

The various levels of assessment, using one or more combined methods of the present invention, will provide the physician with a spectrum of useful information which finds application in circumstances of HSCT which involve prognosis and/or diagnosis and/or treatment regimen. The method of determining the likelihood of a subject to develop acute GVHD described herein, can be used, for example, in analysis of effectiveness of prevention and/or treatment regimens, some examples of which are described herein.

The predetermined levels MCP-1, also referred to as threshold levels, can be determined for the relevant time points by the skilled artisan through studies such as the one detailed in the Examples section below. More specifically, they can be determined through surveyance of a group of individuals who receive a transplant of the relevant organ/tissue type to the subject, (e.g. myeloablative allogeneic HSCT), with analysis of plasma levels of MCP-1 at specific times prior to and throughout the transplant process (e.g. baseline, day 0, day 7, day 14, day 21, etc.). This is coupled to determination of whether and which individuals develop aGVHD, with correlation of the MCP-1 levels to the development, or lack of development, of the aGVHD. Predetermined levels are arrived at by identification of statistically significant, or nearly statistically significant correlations of levels of indicator factors with disease development.

The skilled artisan will recognize that specific predetermined levels identified herein were obtained for a specific transplant type under specific conditions utilized in one study. Additional studies might produce slightly different predetermined levels, which may reflect differences in environmental circumstances and/or the genetic makeup of the populations tested. However, the trends identified herein with respect to RANTES and/or MCP-1 levels apply to any population from which the respective predetermined level(s) is identified. The skilled artisan will also recognize that specific days of analysis/determination of the threshold levels are general reference points, and that analysis within one day plus or minus the specified days herein will provide analogous information. If not identical, at least such analysis will provide information that is useful in the methods disclosed herein. As such, the present invention is intended to encompass the specific levels one day prior to and after the specific time points discussed herein. In one embodiment, the analysis is performed plus or minus 6 hours of the specified time point. In another embodiment, the analysis is performed plus or minus 12 hours of the specified time point. In another embodiment, the analysis is performed plus or minus 24 hours of the specified time point.

The determination of plasma concentration of a factor is typically performed by analysis of a sample obtained from the subject. Generally the sample is blood, which is further processed into plasma. The plasma is then assayed quantitatively for RANTES and/or MCP-1. Applicants envision use of any method of determination that would consistently and accurately provide an indicator which quantitatively indicates or quantitatively relates to the relevant plasma levels of the subject. Alternative processing of a blood sample may also be possible for such a determination of relevant plasma levels in the individual, e.g. use of whole blood or serum. In addition, analysis of other tissues, and/or determination of other factors which indicate RANTES and/or MCP-1 levels is also envisioned

RANTES and/or MCP-1 levels can be determined by any method which quantitatively determines the amount of a molecule(s). One example is flow cytometry of a sample to quantitatively identify the presence of the specific molecule in the sample. In one embodiment, the sample is assayed simultaneously for RANTES and/or MCP-1, and other agents or factors. Alternative means of determination of these levels include, without limitation, quantitative immunology based assays such as ELISA analysis, mass spectroscopy or mass spectrometry. Use of an analytical system that utilizes multianalyte fluorometric beads, such as the Bead Lite Milipore luminex platform would be useful in the invention.

The results obtained from the methods described herein to determine a likelihood of development of aGVHD in a patient find use in a variety of applications. For instance, determination of a likelihood of aGVHD in a transplant candidate may influence the determination as to whether transplantation is indeed the most suitable form of treatment for their condition. In some instances, there may be alternate forms of therapy available which would provide a better prognosis to the patient. Also, prediction of a likelihood of aGVHD would be indicative of the necessity for treatment regimes, or possibly more aggressive treatment regimes than would otherwise be recommended. Such aggressive therapies often have undesireable side effects and so preferably are not used unless prognosis indicates a need. For example, treatment of patients with neutralizing anti-TNF-alpha monoclonal antibodies can result in amelioration of aGVHD, but can increase risk of infections. Various aggressive anti-inflammatory therapies are also available.

The observed correlation of low RANTES in plasma, and also of low MCP-1 in plasma, with the development of aGVHD in a subject indicates that increasing the levels of RANTES and/or MCP-1 in the subject will decrease the subject's susceptibility to aGVHD. As such, another aspect of the invention relates to a method for preventing aGVHD in a subject upon receiving transplant of tissue, organ or cells (e.g. myeloablative allogeneic HSCT). The method comprises increasing the levels of RANTES in the individual. In one embodiment, the levels are increased at one or more of the milestone periods in the HSCT process, described herein (e.g. baseline and day 7 for RANTES, and/or day 0 and day 7 for MCP-1). In another embodiment, the levels are increased at additional time periods as well.

In one embodiment, the levels of RANTES are increased through administration of exogenous bioactive RANTES to the individual. The exogenous RANTES must retain the activity of endogenous RANTES in its therapeutic capacity against aGVHD.

In another embodiment, the levels are increased through administration of an agent that increases RANTES levels or activity in the subject. Such an agent is referred to as an up-modulator of RANTES. Up-modulators are agents that upregulate gene expression (transcription and/or translation) and/or secretion of RANTES, or that down-regulate negative regulation of RANTES activity or expression.

An alternate method is to administer a composition that has an activity of RANTES to the individual. Examples of such a composition would be a synthetic version of the molecule, or a bioactive fragment thereof which retains treatment/prevention activity, such as a modified recombinant version. Another example is a molecular mimic or an active fragment of the molecule. In a preferred embodiment, a bioactive recombinant RANTES is administered.

In one embodiment, the levels of MCP-1 are increased through administration of exogenous bioactive MCP-I to the individual. The exogenous MCP-1 must retain the activity of endogenous MCP-1 in its therapeutic capacity against aGVHD.

In another embodiment, the levels of MCP-1 are increased through administration of an agent that increases MCP-1 levels or activity in the subject. Such an agent is referred to as an up-modulator of MCP-1. Up-modulators are agents that upregulate gene expression (transcription and/or translation) and/or secretion of MCP-1, or that down-regulate negative regulation of MCP-1 activity or expression.

An alternate method is to administer a composition that has an activity of MCP-1 to the individual. Examples of such a composition would be a synthetic version of the molecule, or a bioactive fragment thereof which retains treatment/prevention activity, such as a modified recombinant version. Another example is a molecular mimic or an active fragment of the molecule. In a preferred embodiment, a bioactive recombinant human MCP-1 is administered.

Appropriate routes of administration are to be determined by the skilled practitioner and will depend upon a variety of factors including specific disease symptoms. Routes of administration include, without limitation, dispensing, delivering or applying an active compound in a pharmaceutical formulation to a subject by any suitable route for delivery of the active compound to the desired location in the subject including delivery by either the parenteral or oral route, intramuscular injection, subcutaneous/intradermal injection, intravenous injection, buccal administration, transdermal delivery and administration by the rectal, colonic, vaginal, intranasal or respiratory tract route.

Administration can be via any accepted systemic or local route, for example, via parenteral, oral (particularly for infant formulations), intravenous, nasal, bronchial inhalation (i.e., aerosol formulation), transdermal or topical routes, in the form of solid, semi-solid or liquid or aerosol dosage forms, such as, for example, tablets, pills, capsules, powders, liquids, solutions, emulsion, injectables, suspensions, suppositories, aerosols or the like. Administration can also be in sustained or controlled release dosage forms, including depot injections, osmotic pumps, pills, transdermal (including electrotransport) patches, and the like, for the prolonged administration of the polypeptide at a predetermined rate, preferably in unit dosage forms suitable for single administration of precise dosages. The administered compositions can include a conventional pharmaceutical carrier or excipient and a polypeptide of the invention and, in addition, may include, without limitation, other medicinal agents, pharmaceutical agents, carriers, and adjuvants. Carriers can be selected from the various oils, including those of petroleum, animal, vegetable or synthetic origin, for example, peanut oil, soybean oil, mineral oil, sesame oil, and the like. Water, saline, aqueous dextrose, and glycols are preferred liquid carriers, particularly for injectable solutions. Suitable pharmaceutical carriers include starch, cellulose, talc, glucose, lactose, sucrose, gelatin, malt, rice, flour, chalk, silica gel, magnesium stearate, sodium stearate, glycerol monostearate, sodium chloride, dried skim milk, glycerol, propylene glycol, water, ethanol, and the like. The administered composition may also contain minor amounts of non-toxic auxiliary substances such as wetting or emulsifying agents, pH buffering agents and the like, such as for example, sodium acetate, sorbitan monolaurate, triethanolamine oleate.

Administration of an effective amount of the relevant agent (e.g., RANTES or MCP-1) produces an increase in the RANTES and/or MCP-1 in the individual to a therapeutic level. As used herein, the effective amount includes an amount effective, at dosages and for periods of time necessary, to achieve the desired result. An example of a desired result is, without limitation, production of an increase in levels or ratios to an amount equal to or higher than a predetermined RANTES and/or MCP-1 levels. This may result in a therapeutic effect on the subject with respect to the disease state. Another non-limiting example is the detection of treatment or prevention of aGVHD in a transplant recipient, as defined herein. All are methods of verifying administration of an effective amount and/or increasing the RANTES and/or MCP-1 to a therapeutic level, and can be useful to the skilled practitioner in determining dosage amount, regimen and administration routes.

An effective amount of an active compound as defined herein may vary according to factors such as the disease state, age, and weight of the subject, and the ability of the active compound to elicit a desired response in the subject. Dosage regimens may be adjusted to provide the optimum therapeutic response. An effective amount is also one in which any toxic or detrimental effects of the active compound are outweighed by the therapeutically beneficial effects.

Administration may be in the absence of, or in combination with, other agents for treating or preventing aGVHD. Methotrexate and cyclosporin A are common drugs used for GVHD prophylaxis. In one embodiment, administration of RANTES is in the absence of administration of MCP-1 and/or BPI. In another embodiment, administration of MCP-1 is in the absence of administration of RANTES and/or BP1.

In one embodiment, administration of one or more of the agents described herein is to a subject who has a baseline plasma concentration of RANTES which is below a predetermined threshold level of RANTES. Such a level in a subject is herein referred to as “low baseline plasma concentration of RANTES.” This level falls below a baseline plasma concentration of RANTES observed in a population of HSCT recipients who do not develop aGVHD, the determination of which is described herein. Any increase in baseline plasma RANTES is expected to produce one or more therapeutic benefits described herein. In one embodiment, administration to such a subject is sufficient to increases the subject's baseline plasma concentration of RANTES to average levels, described herein. There may be added benefit to increasing the baseline plasma concentration of RANTES even beyond average levels.

In addition to, or instead of, increasing the baseline plasma concentration of RANTES in a subject, administration of the agent(s) described herein may be such that it increases the plasma concentration of RANTES in the subject at day 7 (herein referred to as the day 7 plasma concentration of RANTES). When also increasing the baseline plasma concentration, the increase can be maintained through day 7, or the subject's plasma RANTES can be monitored, and if the concentration falls, RANTES can be again administered to increase the day 7 plasma concentration as well. In one embodiment, the subject would otherwise exhibit a day 7 plasma concentration that was below a predetermined threshold level of RANTES at day 7, referred to herein as low day 7 plasma concentration of RANTES. Any increase in day plasma RANTES is expected to produce one or more therapeutic benefits described herein. In one embodiment, administration to such a subject is sufficient to increases the subject's day 7 plasma concentration of RANTES to average levels, described herein. There may be added benefit to increasing the day 7 plasma concentration of RANTES even beyond average levels.

In one embodiment, administration is to a subject who has a day 7 plasma concentration of RANTES which is below a predetermined level of RANTES. Such a level in a subject is herein referred to as “low day 7 plasma concentration of RANTES,” the determination of which is analogous to the determination of low baseline plasma concentration of RANTES. Any increase in day 7 plasma RANTES is expected to produce one or more therapeutic benefits described herein. In one embodiment, administration to such a subject is sufficient to increases the subject's day 7 plasma concentration of RANTES to average levels, described herein. There may be added benefit to increasing the day 7 plasma concentration of RANTES even beyond average levels.

In another embodiment, the above described administration is to a subject who has a plasma concentration of RANTES (e.g. at baseline, day 0, and/or day 7) which is not below a predetermined level of RANTES. Such a level in a subject is herein referred to as “average baseline plasma concentration of RANTES,” or “average day 0 plasma concentration of MCP-1,” or “average day 7 plasma concentration of RANTES,” respectively. This level falls within a plasma concentration of RANTES observed in a population of HSCT recipients on the specified day who do not develop aGVHD, the determination of which is described herein.

In one embodiment, administration of the agent(s) described herein is to a subject who has a day 0 plasma concentration of MCP-1 which is below a predetermined threshold level of MCP-1. Such a level in a subject is herein referred to as “low day 0 plasma concentration of MCP-1.” This level falls below a day 0 plasma concentration of MCP-1 observed in a population of HSCT recipients who do not develop aGVHD, the determination of which is described herein. Any increase in day 0 plasma concentration of MCP-1 is expected to produce one or more therapeutic benefits described herein. In one embodiment, administration to such a subject is sufficient to increases the subject's day 0 plasma concentration of MCP-1 to average levels, described herein. There may be added benefit to increasing the day 0 plasma concentration of MCP-1 even beyond average levels.

In addition to, or instead of, increasing the day 0 plasma concentration of MCP-1 in a subject, administration may be such that it increases the plasma concentration of MCP-1 in the subject at day 7 (herein referred to as the day 7 plasma concentration of MCP-1). When also increasing the day 0 plasma concentration, the increase can be maintained through day 7, or the subject's plasma MCP-1 can be monitored, and if the concentration falls, MCP-1 can be again administered to increase the day 7 plasma concentration as well. In one embodiment, the subject would otherwise exhibit a day 7 plasma concentration that was below a predetermined threshold level of MCP-1 at day 7, referred to herein as low day 7 plasma concentration of MCP-1. Any increase in day 7 plasma MCP-1 is expected to produce one or more therapeutic benefits described herein. In one embodiment, administration to such a subject is sufficient to increases the subject's day 7 plasma concentration of MCP-1 to average levels, described herein. There may be added benefit to increasing the day 7 plasma concentration of MCP-1 even beyond average levels.

In one embodiment, administration is to a subject who has a day 7 plasma concentration of MCP-1 which is below a predetermined level of MCP-1. Such a level in a subject is herein referred to as “low day 7 plasma concentration of MCP-1,” the determination of which is analogous to the determination of low day 0 plasma concentration of MCP-1. Any increase in day 7 plasma MCP-1 is expected to produce one or more therapeutic benefits described herein. In one embodiment, administration to such a subject is sufficient to increases the subject's day 7 plasma concentration of MCP-1 to average levels, described herein. There may be added benefit to increasing the day 7 plasma concentration of MCP-1 even beyond average levels.

In another embodiment, the above described administration is to a subject who has a plasma concentration of MCP-1 (e.g. at day 0, and/or day 7) which is not below a predetermined level of MCP-1. Such a level in a subject is herein referred to as “average day 0 plasma concentration of MCP-1,” or “average day 7 plasma concentration of MCP-1,” respectively. This level falls within a plasma concentration of MCP-1 observed in a population of HSCT recipients on the specified day who do not develop aGVHD, the determination of which is described herein.

Administration as described herein, can be prolonged or repeated over time such that increased levels at specified times are maintained as long as the skilled practitioner determines is necessary and/or therapeutic (e.g. for 1, 2, 3, 4, . . . to 30 days, or for 1, 2, 3, 4, . . . up to 6 months).

The observed correlation of low RANTES in plasma of a donor of hematopoetic stem cells with the development of aGVHD in a subject indicates that increasing the levels of plasma RANTES in the donor will decrease the subject's susceptibility to aGVHD. As such, another aspect of the invention relates to a method for preventing aGVHD in a subject upon receiving transplant (e.g. myeloablative allogeneic HSCT). The method comprises increasing the plasma levels of RANTES in the donor.

Acceptable means for increasing the plasma level of RANTES described herein for a subject/recipient of the transplant also apply to increasing plasma levels of RANTES in a donor. Administration of RANTES or another such agent can be by any route described herein, and can be optimally determined by the skilled practitioner.

In one embodiment, administration is to a donor who has a plasma concentration of RANTES which is below a predetermined threshold level of RANTES. Such a level in a donor is herein referred to as “low donor plasma concentration of RANTES.” This level falls below a baseline plasma concentration of RANTES observed in a population of donors whose transplant recipients do not develop aGVHD, the determination of which is described herein. Any increase in donor plasma RANTES is expected to produce one or more therapeutic benefits described herein. In one embodiment, administration to such a subject is sufficient to increases the donor's plasma concentration of RANTES to average levels,

In another embodiment, the above described administration is to a donor who has a plasma concentration of RANTES which is not below a predetermined level of RANTES. Such a level in a donor is herein referred to as “average baseline plasma concentration of RANTES.” This level falls within a plasma concentration of RANTES observed in a population of donors whose transplant recipients do not develop aGVHD, the determination of which is described herein. There may be added benefit to increasing the donor plasma concentration of RANTES even beyond average levels

In one embodiment the method is performed such that the increase in plasma level of RANTES takes place by/at the time of donation of the tissue (e.g., hematopoetic stem cells). There may be added benefit to prolonged increase in the plasma RANTES of the donor for a time period prior to donation (e.g. for 1, 2, 3, 4, 5, 6 days, 1, 2, 3, 4 weeks, or for several months).

Increasing the plasma levels of RANTES in the donor is expected to provide added benefit when the subject to receive the transplant has a likelihood of development of aGVHD due to reduced amount of their own plasma levels of RANTES (e.g. low baseline or low day 7 plasma RANTES) or another such marker.

Increasing the plasma levels of RANTES in the donor can be combined with one or more other methods of treating/preventing aGVHD in a subject, described herein. Such a combination is expected to provide added therapeutic benefit to the subject.

Prevention is achieved by administration prior to disease onset or significant development of disease symptoms. As used herein, the term preventing refers to the complete prevention of disease onset and/or symptoms, or the lessening of the severity of disease and/or disease symptoms in a subject, and/or delaying one or more symptoms of disease, and/or delaying the onset of disease and/or disease symptoms.

Treatment is achieved by administration after disease onset or significant development of disease symptoms. Effective treatment results in amelioration, partial or complete of disease symptoms. Typical symptoms of aGVHD include T cell and/or platelet production of an excess of cytokines, including TNF alpha and interferon-gamma (IFNg). Classical symptoms of acute graft-versus-host-disease are selective damage to the liver, skin and mucosa, and the gastrointestinal tract. Other graft-versus-host-disease target organs include the immune system (the hematopoietic system—e.g. the bone marrow and the thymus) itself, and the lungs in the form of idiopathic pneumonitis. Acute GVHD of the GI tract can result in liters of watery diarrhea per day, abdominal pain, nausea, and vomiting. This is typically diagnosed via intestinal biopsy. Liver GVHD is measured by the bilirubin level in acute patients. Skin GVHD results in a diffuse maculopapular rash, sometimes in a lacy pattern. Acute GVHD is staged. Overall grade (skin-liver-gut) with each organ staged individually from a low of 1 to a high of 4. Patients with grade IV GVHD usually have a poor prognosis. If the GVHD is severe and requires intense immunosuppression involving steroids and additional agents to get under control, the patient may develop severe infections as a result of the immunosuppression and may die of infection.

A wide range of host antigens can initiate graft-versus-host-disease, among them the human leukocyte antigens (HLAs). However, graft-versus-host disease can occur even when HLA-identical siblings are the donors. HLA-identical siblings or HLA-identical unrelated donors often have genetically different proteins (called minor histocompatibility antigens) that can be presented by MHC molecules to the recipient's T-cells, which see these antigens as foreign and so mount an immune response. As such, the methods and compositions described herein are applicable to treat or prevent aGVHD which arises from myeloablative syngeneic HSCT in a subject. Specific predetermined levels of plasma RANTES and/or MCP-1 in the subject and donor can be determined by using analogous populations of syngeneic HSCT recipients and donors, as adapted by the skilled practitioner.

The experiments detailed herein indicate that RANTES and/or MCP-1 levels in the plasma of a subject are indicative of the inflammatory state within the individual. As such, RANTES and/or MCP-1 levels, can be used as markers for inflammation in a subject. Using such levels as markers can provide information as an early warning with respect to the development or exacerbation of an inflammatory disease or disorder in the subject. Such knowledge would be applied by the skilled practitioner to initial a treatment or prevention regimen which lessens or prevents inflammatory disease/disorder development in the subject. For example, such methods could be applied to subjects with genetic predispositions or subject to environmental risk factors that lead to development of inflammatory related diseases or conditions.

Aspects of the present invention relate to a method for determining the likelihood of a subject to develop an inflammatory response. The method comprises, assaying for plasma concentration of MCP-1 and/or RANTES in a sample obtained from the subject, and comparing the plasma concentration MCP-1 and/or RANTES to a predetermined level. A plasma concentration of MCP-1 and/or RANTES less than the predetermined level indicates a likelihood of a subject to develop an inflammatory response.

Once a predisposition is determined by the methods described herein, the subject with the predisposition (also referred to herein as an increased likelihood) can be further treated with anti-inflammatory agents to reduce their risk. As such, another aspect of the present invention relates to a method of treating or preventing inflammation in a subject at increased risk for development of inflammation. The method comprises identifying a subject with an increased risk of developing an inflammatory response, by the methods described herein, and administering an anti-inflammatory agent to the subject thereby treat or prevent the inflammation.

Analysis of RANTES and/or MCP-1, can optionally be performed in conjunction with analysis of known inflammatory biomarkers. Such biomarkers include, but are not limited to CRP, cytokines associated with inflammation, such as members of the interleukin family, including IL-1 through IL-17 that are associated with inflammation, TNF-alpha; B61; certain cellular adhesion molecules, such as for example, e-selectin (also known as ELAM), sICAM, integrins, ICAM-1, ICAM-3, BL-CAM, LFA-2, VCAM-1, NCAM and PECAM; neopterin; serum procalcitonin; leukotriene, thromboxane, and isoprostane.

With respect to the likelihood of developing an inflammatory response, the respective predetermined levels RANTES or MCP-1, can be determined through adaptation of the methods disclosed herein, to one or more conditions known to be exacerbated, caused by, lead to, or be associated with the development of inflammation. More specifically, the predetermined levels can be determined through surveyance of a group of individuals who are at risk for increased, inflammation. (e.g., due to the predisposition to an inflammatory disease or disorder, being at risk for injury or disease that leads to inflammation, etc.), with analysis of plasma levels of RANTES and/or MCP-1 at specific times prior to and throughout the monitored time period (e.g., baseline, prior to increased risk onset, prior to development of symptoms, following injury or infection). Specific time points could generally reflect the time points reported herein for the analysis of RANTES and MCP-1 levels in the development of aGVHD in a subject. This is coupled to determination of whether and which individuals develop inflammation or inflammatory symptoms as diagnosed by any variety of methods known in the art. The RANTES and/or MCP-1 levels are then correlated to the development, or lack of development, of the inflammation or inflammatory symptoms. This can be performed using a group of individuals linked to a condition in common (e.g., subjects who have received surgery, hospitalized subjects, subjects with the same disease or condition, etc.). The study can also further be expanded to include a variety of such conditions. Predetermined levels are arrived at by identification of statistically significant, or nearly statistically significant correlations of levels of indicator factors with disease development.

In one embodiment, the inflammation is harmful to the condition of the subject.

Subjects at risk for increased inflammation include those who suffer from an inflammatory disease or disorder, subjects who are genetically predisposed for such an inflammatory disease or disorder, subjects who are at risk for injury or infection that leads to inflammation. Such injury can be an injury to a barrier tissue, either a primary or secondary barrier to the environment (e.g., skin, gut, liver, lung. One such group of individuals are subjects who undergo surgery. Another such group are subjects to are at increased risk of developing sepsis (e.g., hospital patients).

The term “inflammatory disease or disorder” as used herein, refers to any disorder that is either caused by inflammation or whose symptoms include inflammation, or is otherwise associated with inflammation. One such inflammatory disorder caused by inflammation is septic shock, and an inflammatory disease whose symptoms include inflammation is rheumatoid arthritis. Inflammation is associated with a number of diseases or disorders, for example, neurodegenerative diseases, cardiovascular disease or disorders, and infectious diseases. The inflammatory disorders of the present invention include but are not limited to: diabetes-associated nephropathy and retinopathy, protein wasting, muscle fatigue or inflammation, coronary artery disease, inflammatory bowel disease, atherosclerosis and other cardiovascular diseases, Alzheimer's disease, myocarditis, cardiomyopathy, pancreatitis, HIV disease and AIDS, complication of AIDS or cancer therapy, celiac disease, cystic fibrosis, acute endocarditis, pericarditis, hepatitis, Systemic Inflammatory Response Syndrome (SIRS)/sepsis, adult respiratory distress syndrome (ARDS), asthma, rheumatoid arthritis, osteoarthritis, systemic lupus erythematosis, airway hyperresponsiveness (AHR), bronchial hyperreactivity, chronic obstructive pulmonary disease (COPD), congestive heart failure (CHF), inflammatory complications of diabetes mellitus, inflammatory bowel disease (CROHN's disease and/or ulcerative colitis) to either induce remission and/or prevent relapse, metabolic syndrome, non-alcoholic fatty liver disease, end stage renal disease (ESRD), and dermatitis. Another inflammatory condition which can be treated is major burns (e.g. second or third degree burns). In one embodiment, the major burns cover more than 20% body surface area. Another inflammatory condition which can be treated/prevented is traumatic brain injury (e.g. with a Glasgow Coma Score less than 8). Multiple trauma as well as any critical illness producing APACHE III scores of greater than 10 can also be treated. Another condition which can be treated by the methods of the present invention is receipt of a stem cell transplant or a bone marrow transplant.

“Inflammation” or “inflammatory symptoms” refers to one or more biological and physiological sequelae including: vasodilatation; increased vascular permeability; extravasation of plasma leading to interstitial edema; chemotaxis of neutrophils, macrophages and lymphocytes; cytokine production; acute phase reactants; C-reactive protein (CRP); increased erythrocyte sedimentation rate; leukocytosis; fever; increased metabolic rate; impaired albumin production and hypoalbuminemia; activation of complement; and stimulation of antibodies.

As used herein, “cardiovascular disease” includes diseases associated with the cardiopulmonary and circulatory systems including but not limited to ischemia, angina, edematous conditions, artherosclerosis, CHF, LDL oxidation, adhesion of monocytes to endothelial cells, foam-cell formation, fatty-streak development, platelet adherence, and aggregation, smooth muscle cell proliferation, reperfusion injury, high blood pressure, and thrombotic disease.

As used herein, a “symptom” of an inflammatory condition includes physical symptoms (pain, edema, erythema, and the like) associated with a particular inflammatory condition, and/or biomarkers associated either generally with inflammation or particularly with a specific inflammatory condition.

The present invention may be as defined in any one of the following numbered paragraphs.

1. A method for determining the likelihood of a subject to develop acute graft versus host disease (aGVHD) upon receiving myeloablative allogeneic hematopoietic stem cell transplantation (HSCT), comprising:

a) assaying for baseline plasma concentration of RANTES in a sample obtained from the subject; and
b) comparing the baseline plasma concentration of RANTES to a predetermined level; wherein a baseline plasma concentration of RANTES less than the predetermined level indicates a likelihood of the subject to develop aGVHD upon receiving myeloablative allogeneic HSCT.

2. The method of paragraph 1 wherein the predetermined level is about 20,000 pg/ml plasma.

3. The method of paragraph 2 further comprising:

a) assaying for day 7 plasma concentration of RANTES in a sample obtained from the subject; and
b) comparing the day 7 plasma concentration of RANTES to a predetermined level; wherein a day 7 plasma concentration of RANTES less than the predetermined level indicates a likelihood of the subject to develop aGVHD upon receiving HSCT.

4. A method for determining the likelihood of a subject to develop acute graft versus host disease (aGVHD) upon receiving myeloablative allogeneic hematopoietic stem cell transplantation (HSCT), comprising:

a) assaying for day 7 plasma concentration of RANTES in a sample obtained from the subject; and
b) comparing the day 7 plasma concentration of RANTES to a predetermined level; wherein a day 7 plasma concentration of RANTES less than the predetermined level indicates a likelihood of the subject to develop aGVHD upon receiving myeloablative allogeneic HSCT.

5. The method of paragraph 1 and 4 wherein the plasma concentration of RANTES is determined by flow cytometry.

6. The method of paragraph 4 wherein the predetermined levels that the day 7 plasma concentration of RANTES is compared to is about 2,000 pg/ml plasma.

7. A method for determining the likelihood of a subject to develop acute graft versus host disease (aGVHD) upon receiving myeloablative allogeneic hematopoietic stem cell transplantation (HSCT), comprising:

a) assaying for donor plasma concentration of RANTES in a sample obtained from a donor of the hemtopoietic stem cells; and
b) comparing the donor plasma concentration of RANTES determined in step a) to a predetermined level;
wherein a donor plasma concentration of RANTES less than the predetermined level indicates a likelihood of the subject to develop aGVHD upon receiving myeloablative allogeneic HSCT from that donor.

8. The method of paragraph 7 wherein predetermined levels is about 60,000 pg/ml plasma.

9. A method for determining the likelihood of a subject to develop acute graft versus host disease (aGVHD) upon receiving myeloablative allogeneic hematopoietic stem cell transplantation (HSCT), comprising:

a) assaying for day 0 plasma concentration of MCP-1 in a sample obtained from the subject; and
b) comparing the day 0 plasma concentration of MCP-1 to a predetermined level; wherein a day 0 plasma concentration of MCP-1 less than the predetermined level indicates a likelihood of the subject to develop aGVHD upon receiving HSCT.

10. The method of paragraph 9 wherein the predetermined level is about 400 pg/ml plasma.

11. The method of numbered paragraph 10 further comprising determining the day 7 plasma concentration of MCP-1 of the subject, wherein a low day 7 plasma concentration of MCP-1 indicates an increased likelihood of the subject developing aGVHD upon receiving HSCT.

12. A method for determining the likelihood of a subject to develop acute graft versus host disease (aGVHD) upon receiving myeloablative allogeneic hematopoietic stem cell transplantation (HSCT), comprising:

a) assaying for day 7 plasma concentration of MCP-1 in a sample obtained from the subject; and
b) comparing the day 7 plasma concentration of MCP-1 to a predetermined level; wherein a day 7 plasma concentration of MCP-1 less than the predetermined level indicates a likelihood of the subject to develop aGVHD upon receiving HSCT.

13. The method of numbered paragraph 10 and 12 wherein the plasma concentration of MCP-1 is determined by flow cytometry.

14. The method of paragraph 12 wherein the predetermined level to which the day 7 plasma concentration of MCP-1 is compared is about 700 pg/ml plasma.

15. A method for determining the likelihood of a subject to develop an inflammatory response comprising,

a) assaying for plasma concentration of MCP-1 and/or RANTES in a sample obtained from the subject; and
b) comparing the plasma concentration MCP-1 and/or RANTES to a predetermined level;
wherein a plasma concentration of MCP-1 and/or RANTES less than the predetermined level indicates a likelihood of a subject to develop an inflammatory response.

16. The method of paragraph 15, wherein subject identified as having a likelihood to develop an inflammatory response is treated prophylactically with one or more anti-inflammatory agents.

Unless otherwise defined herein, scientific and technical terms used in connection with the present application shall have the meanings that are commonly understood by those of ordinary skill in the art. Further, unless otherwise required by context, singular terms shall include pluralities and plural terms shall include the singular.

It should be understood that this invention is not limited to the particular methodology, protocols, and reagents, etc., described herein and as such may vary. The terminology used herein is for the purpose of describing particular embodiments only, and is not intended to limit the scope of the present invention.

Other than in the operating examples, or where otherwise indicated, all numbers expressing quantities of ingredients or reaction conditions used herein should be understood as modified in all instances by the term “about.” The term “about” when used in connection with percentages may mean ±1%, ±2%, ±5%, ±10%.

In one respect, the present invention relates to the herein described compositions, methods, and respective component(s) thereof, as essential to the invention, yet open to the inclusion of unspecified elements, essential or not (“comprising). In some embodiments, other elements to be included in the description of the composition, method or respective component thereof are limited to those that do not materially affect the basic and novel characteristic(s) of the invention (“consisting essentially of”). This applies equally to steps within a described method as well as compositions and components therein. In other embodiments, the inventions, compositions, methods, and respective components thereof, described herein are intended to be exclusive of any element not deemed an essential element to the component, composition or method (“consisting of”).

All patents, patent applications, and publications identified herein are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

### Examples

An observational cohort study was designed to determine whether LPS-modulating proteins are perturbed during myeloablative HSCT. Patients of myeloablative, allogenic HSCT were tested at various time points in the transplant process for the presence of LPS-modulating proteins. The progress of the patients was followed after the transplant and levels of the LPS-modulating proteins of the patients was correlated with the development, or absence of development of acute graft-versus-host disease (aGVHD). In addition to documenting significant changes in these proteins suggesting the presence of bioactive endotoxin early during myeloablative HSCT, patients who developed aGVHD were observed to have lower plasma BPI/LBP, RANTES and MCP-1 at specific times in the transplant process, as compared to plasma BPI/LBP, RANTES and MCP-1 of similarly treated patients who did not develop aGVHD. These statistically significant results indicate that the levels of these proteins, measured at critical time points in the transplant process, can determine a propensity of an individual to develop aGVHD. These results also indicate that stategies designed to replenish deficient endotoxin antagonists will provide a means to reduce toxicities associated with myeloablative HSCT, and potentially prevent development of aGVHD altogether.

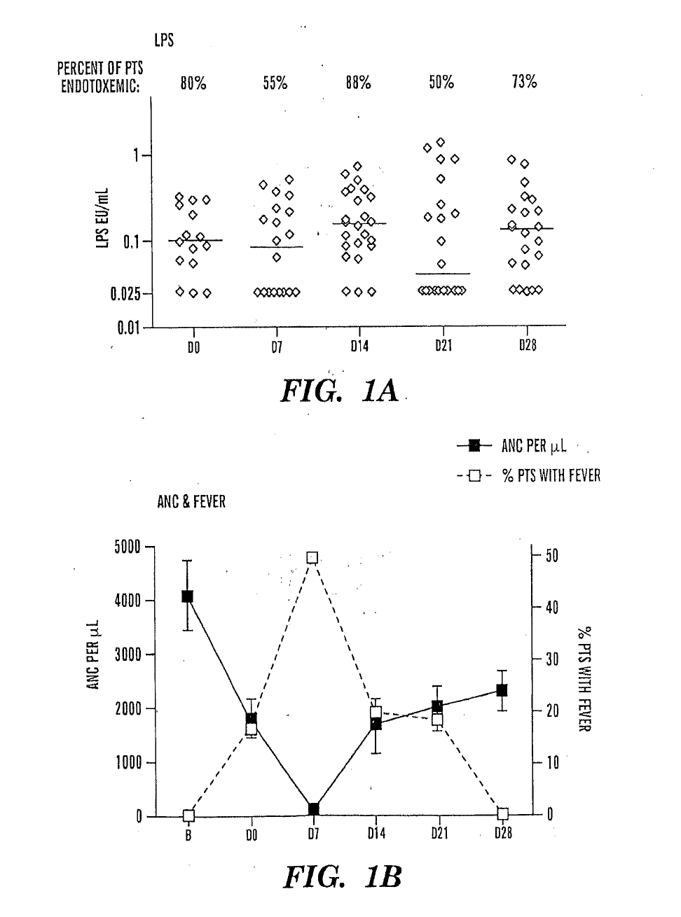

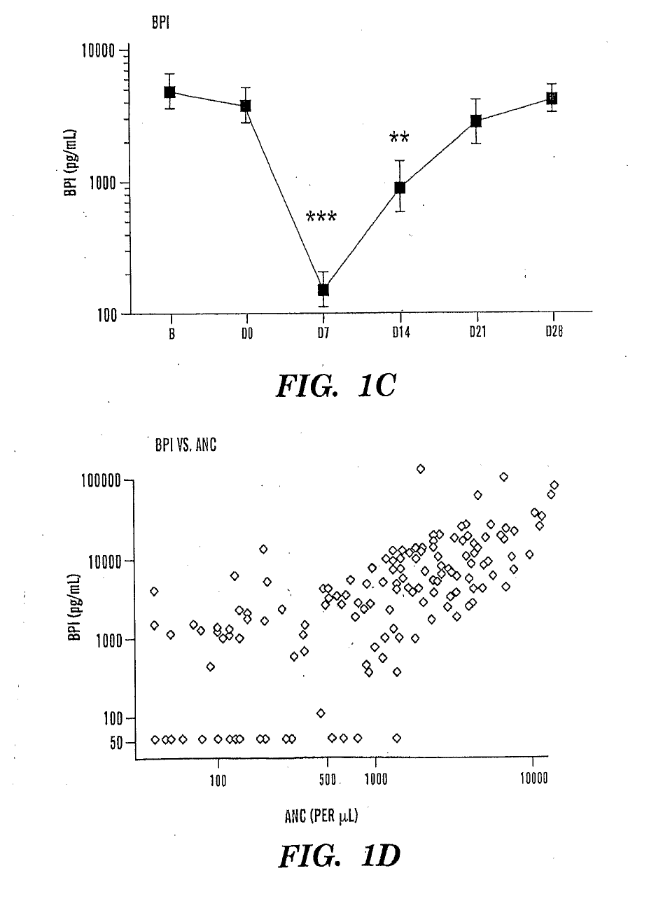

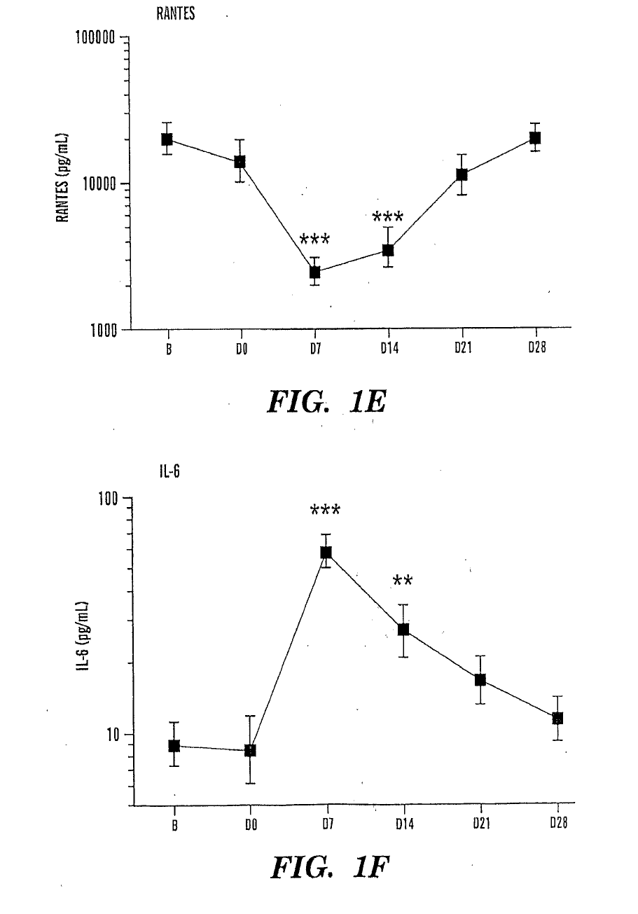

Endotoxin was detected in >50% of patient plasma samples at each time-point tested (FIG. 1A). Nearly 90% of the 30 patients had endotoxemia at some time. Fever was observed in most patients, most commonly at D7 (FIG. 1B, broken line), corresponding to the nadir in ANC (FIG. 1B, solid line) and coincident with increases in plasma IL-6 (FIG. 1F). The conditioning regimen-induced nadir of ANC at D7 (mean ANC/μL=69; FIG. 1B) was accompanied by an equally profound (>10-fold) decline in plasma BPI concentrations (FIG. 1C), with no plasma BPI detectable (<50 pg/mL) on D7 in 20/30 patients (67%). Plasma BPI concentrations correlated with ANC (Spearman r=0.69; p<0.0001; FIG. 1D). Plasma concentrations of RANTES also were profoundly reduced at D7 (p<0.001) and D14 (p<0.0001) (FIG. 1E). In contrast, plasma IL-6 concentrations were highest at D7 (p<0.0001) and D14 (p<0.01; FIG. 1F). These results confirm frequent endotoxemia in patients undergoing myeloablative HSCT¹² and demonstrate severe deficiencies of negative regulators of endotoxin signaling, BPI and RANTES coincident with the incidence of fever, lowest circulating neutrophil levels, and highest plasma IL-6 concentrations.

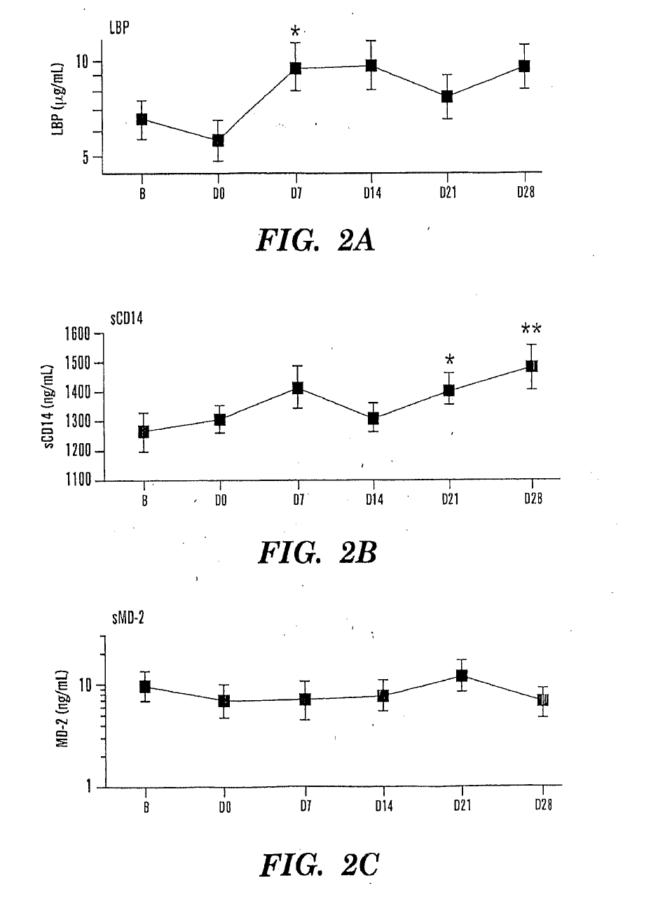

Plasma levels of three additional LPS-interactive proteins LBP, sCD14, and sMD-2 were also measured (FIG. 2). Statistically significant increases in plasma levels of both LBP (FIG. 2A) and sCD14 (FIG. 2B) were observed, with greater and earlier (D7) increases for LBP consistent with induction of an acute phase response. In contrast, plasma concentrations of sMD-2 did not change significantly (FIG. 2C).

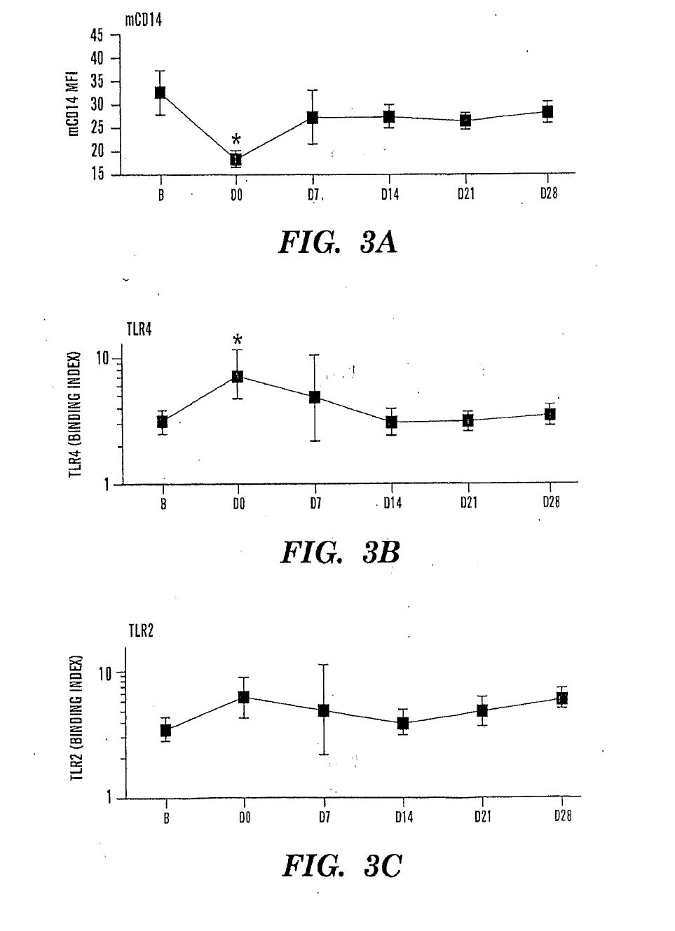

Exposure of monocytes to endotoxin results in decreased surface mCD14³⁶ and increased surface TLR4³⁷. We therefore monitored surface expression of mCD14 and TLR4 on the patients' PB monocytes (FIG. 3). Significant (p<0.05, one-sided) changes in monocyte surface mCD14 (decreased; FIG. 3A) and surface TLR4 (increased; FIG. 3B), but not TLR2 (FIG. 3C), were observed at D0, consistent with bloodstream exposure of the patients to bioactive endotoxin at this time.

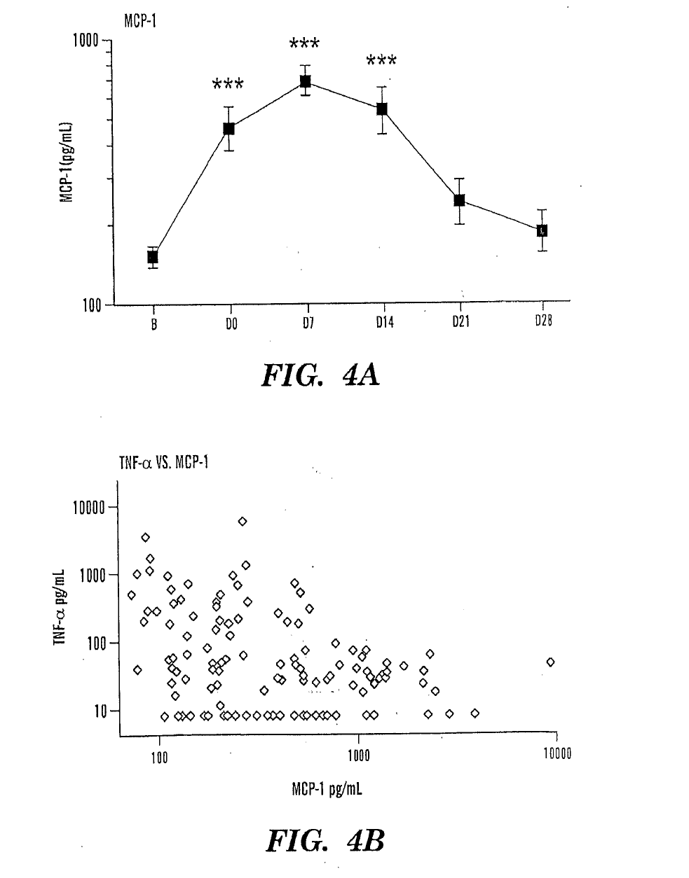

Also indicative of early systemic inflammatory responses in patients undergoing myeloablative HSCT, plasma concentrations of MCP-1 rose dramatically on D0 (p<0.0001) and remained elevated through D14 (FIG. 4A; p<0.0001). MCP-1 concentrations inversely correlated with spontaneous TNF-α elaboration (FIG. 4B; Spearman r=−0.56, p<0.0001), consistent with reported inhibitory effects of MCP-1 on LPS-induced TNF-α production³³.

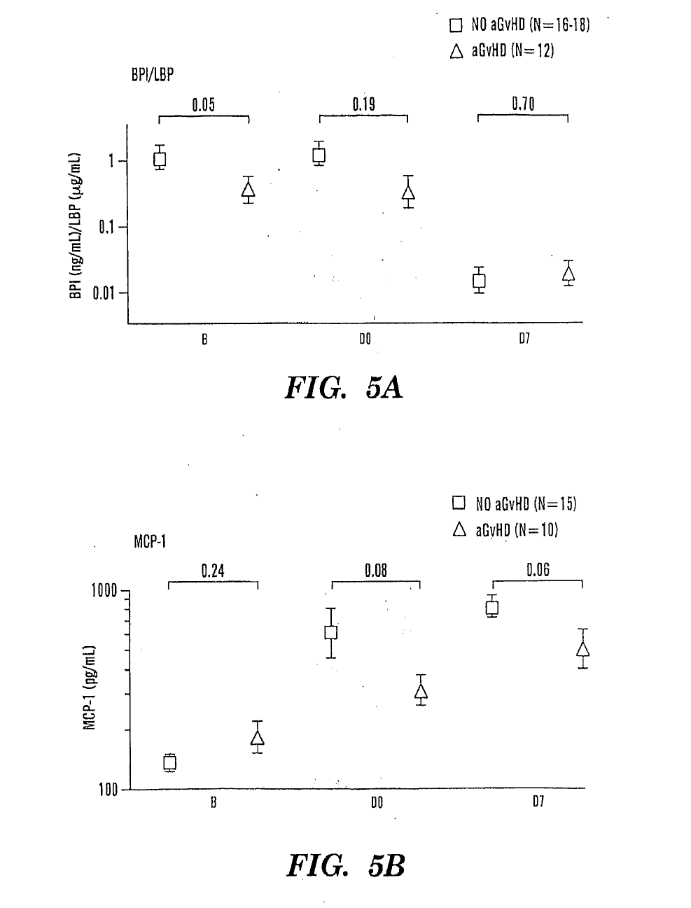

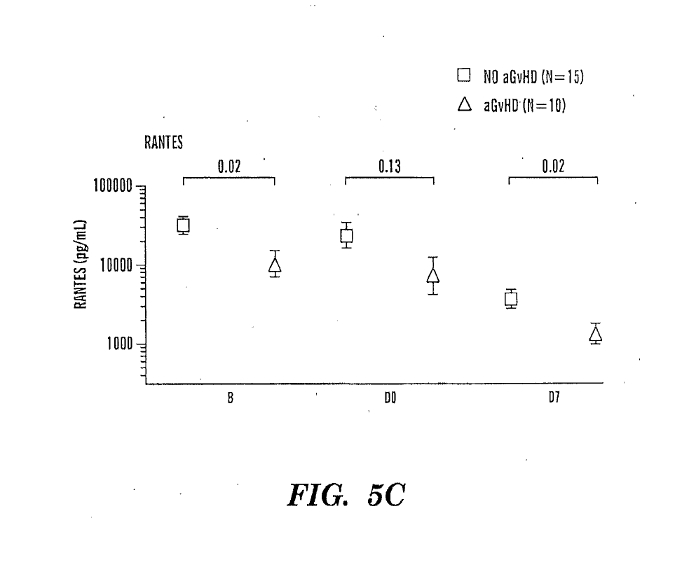

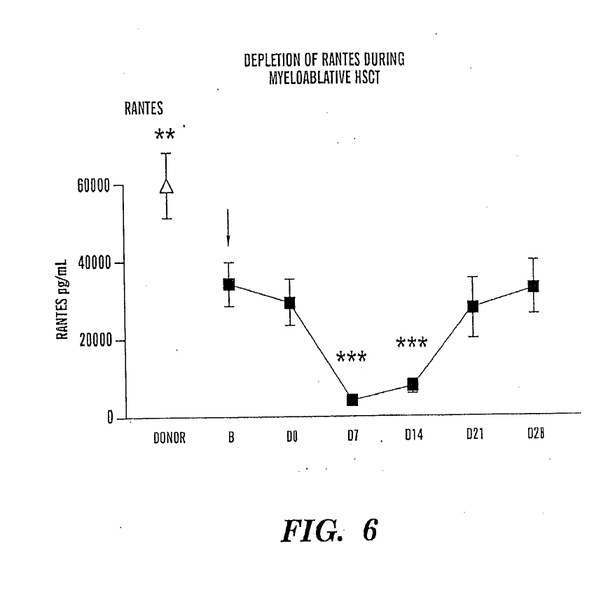

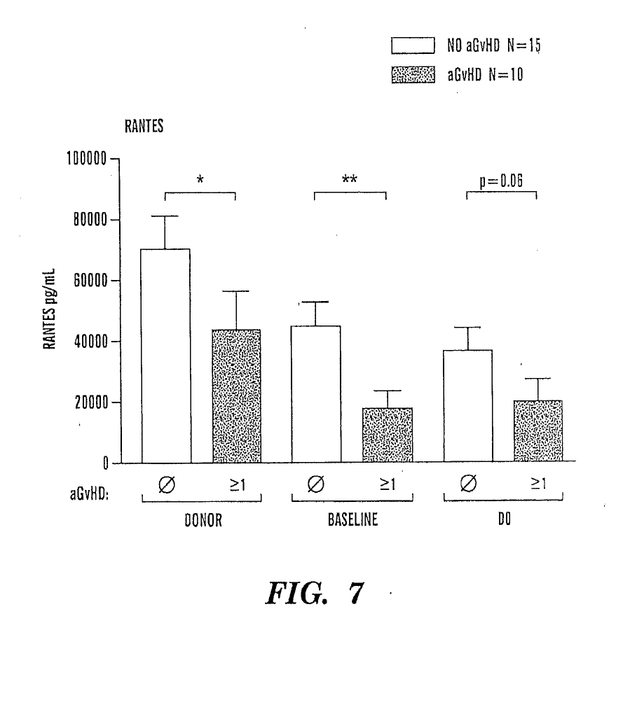

Given the dramatic changes in plasma levels of proteins that regulate host responses to LPS, we compared levels of these proteins in patients who did or did not develop aGVHD (FIG. 5). Patients who subsequently developed aGVHD had a significantly lower baseline ratio of BPI/LBP (p=0.05, FIG. 5A), lower MCP-1 concentrations at D0 and D7 (p=0.06-0.08; FIG. 5B), and lower plasma concentrations of RANTES at baseline and D7 (both p<0.05; FIG. 5C). These data were further analyzed by a logistic regression model, focusing on a time point for each marker that was most promising as a predictor in the unadjusted analysis (FIG. 5; BPI/LBP ratio at baseline, RANTES at baseline, MCP-1 at D0) as well as LBP at baseline (that also showed association with aGVHD; p=0.08, Mann-Whitney test). This logistic regression analysis found an association between plasma concentrations of LBP and RANTES at baseline and of MCP-1 at D0 with the occurrence of aGVHD that was nearly statistically significant for each of the three variables (0.05≦p≦0.07). These results support the hypothesis that RANTES, MCP-1 and LBP each independently contribute to the occurrence of aGVHD.

### Discussion:

Studies in myeloablated mice strongly suggest that translocation of LPS from the intestine to the peripheral circulation triggers TLR4-dependent production of TNF-α and other pro-inflammatory cytokines that promote subsequent development of regimen-related toxicities, including aGVHD¹⁰. In these murine models, blocking LPS, TLR4 and/or TNF-α actions either prior to or immediately after murine HSCT substantially reduces mortality and the occurrence and severity of aGVHD¹¹, indicating an early and important role for endotoxin-directed innate immunity. Similarly, in humans, early elevation of TNF-α is significantly associated with subsequent regimen-related toxicities^{38,39}, including aGVHD and occurrence of early aGVHD may decrease with reduced intensity of conditioning. Our current findings document early endotoxemia in human myeloablative HSCT (FIG. 1A). It is likely, given efficient mechanisms for LPS clearance from the bloodstream and our intermittent sampling, that the high frequency of endotoxemia we document is still an underestimate of the cumulative bloodstream endotoxin exposure in these patients.

We also observed several cellular and humoral inflammatory changes consistent with early endotoxin action in patients undergoing myeloablative HSCT. Monocytes examined on D0 showed reduced surface mCD14 and increased TLR4, as well as “spontaneous” TNF-α elaboration (FIG. 3), indicating in vivo activation of these cells soon after conditioning. Early manifestations of an acute phase response (D7) included fever, as well as increased plasma IL-6 and LBP concentrations (FIG. 1). We noted that peak incidence of fever (FIG. 1B) and plasma IL-6 concentrations (FIG. 1F) coincided at D7, and returned to normal levels by D28, despite apparently persistent or recurrent endotoxemia (FIG. 1A). As the kinetics of plasma IL-6 mobilization were nearly identical to that of the decline in plasma concentrations of BPI (FIG. 1C) and RANTES (FIG. 1E), these observations strongly suggest that the pro-inflammatory action of endotoxin was linked not just to endotoxemia, but rather the combination of endotoxemia and deficiencies in negative regulators of LPS action induced by myeloablative conditioning. The marked decline in plasma BPI levels was clearly linked to conditioning-induced neutropenia (FIG. 1D) whereas the decline in plasma RANTES levels is likely thrombocytopenia⁴⁰. In addition to their roles in limiting endotoxn-induced TNF-α production, both BPI and RANTES also possesses direct antibacterial activity as antimicrobial proteins/peptides^{30,41}. Deficiency in these factors during myeloablative HSCT may compromise host defense on that basis as well.

Our study also revealed differences among patients undergoing myeloablative HSCT in the magnitude of deficiencies in endogenous negative regulators of LPS-induced TNF-α production that correlated with differences in risk of aGVHD. This correlation further supports the concept that it is not endotoxemia per se but rather the combination of endotoxemia with deficiencies in endogenous regulators of endotoxin action that places patients undergoing myeloablative HSCT at increased risk for aGVHD. The significant association of low baseline BPI/LBP ratios and RANTES levels with increased risk of aGVHD (FIG. 5A & C), suggests a predisposition in these individuals for greater pro-inflammatory responses to endotoxin. In addition, the association of low RANTES and MCP-1 concentrations at D7 with subsequent development of aGVHD (FIG. 5B & C) suggests that measurable differences in early host responses involving negative regulators of endotoxin action also contribute to differences in outcome. RANTES deficiency has also been associated with poor outcome in meningococcal sepsis⁴², a condition driven by massive endotoxemia⁴³.

There is an unmet medical need for modalities that safely prevent and/or treat aGVHD. Treatment of patients with neutralizing anti-TNF-α monoclonal antibodies has resulted in amelioration of aGVHD^{18,44,} but can increased risk of infections⁴⁵. In murine models, LPS antagonists¹¹, defects in LPS responsiveness due to hypomorphic mutations of TLR4¹⁰, as well as LPS immunization prior to transplant⁴⁶ have proven protective against GVHD. Our data suggest that modalities that antagonize LPS-induced production of TNF-α and other pro-inflammatory/Th1-polarizing cytokines may also improve outcomes after human myeloablative HSCT. Such approaches could include replenishment of BPI by infusion of recombinant BPI congeners⁴⁷, use of lipid A antagonists^{11,48} or, conceivably, replenishment of RANTES. Selective blockade of LPS offers the possibility of inhibiting a pro-inflammatory toxin while preserving both appropriate responses to other microbial stimuli and desirable graft-versus-leukemia/lymphoma effects. Accordingly, a phase I/II study of rBPI₂₁ (Opebecan; XOMA (U.S.) L.L.C.), a bioactive recombinant N-terminal human BPI fragment with in vivo endotoxin-neutralizing activity⁴⁹⁻⁵¹, has been initiated in patients undergoing myeloablative HSCT.

### Materials and Methods:

### Patients.

Patients (N=30) undergoing myeloablative allogeneic HSCT ranged from 1-58 years of age (57%≧21 years); 60% were male. Initial diagnoses were: 16 acute leukemias (8 acute lymphoblastic leukemia, 8 acute myeloblastic leukemia), 4 chronic myeloid leukemia, 1 chronic lymphoid leukemia, 4 myelodysplasia, 2 Hodgkin's and 1 non-Hodgkin's lymphoma, and 2 aplastic anemia. Patients at Children's Hospital Boston (CHB) received bone marrow as their stem cell source while those at Brigham and Women's Hospital (BWH) received peripheral blood stem cells (PBSC). Medical records were reviewed by research staff with established expertise in grading GVHD. The study was approved by Institutional Review Boards at each of the hospitals. All participants and/or guardians gave consent and assent as age-appropriate. Routine supportive care included acyclovir antiviral prophylaxis for herpes sero-positive individuals, fluconazole, voriconazole, or liposomal amphotericin for fungal prophylaxis as well as screening and treatment for CMV reactivation. Prophylactic oral non-absorbable antibiotics were administered for “gut decontamination”: bacitracin and polymyxin at BWH and polymyxin and vancomycin at CHB. Paitents with symptoms and/or asymptomatic temperature >38.0° C. were evaluated for infection. Fever was scored at the time of each blood draw using maximal temperature recorded in the medical record within ±1 day of sample acquisition. Antibiotics were initiated per the judgment of the medical team. 53% of patients had ≧1 documented infection and 17% had ≧2 documented infections. aGVHD was graded according to the modified Glucksberg scoring system³⁴, and observed in 23% of children and 56% of adults.

### Procedures.

Peripheral blood (PB) was collected from recipients prior to HSCT conditioning (baseline), on the day of HSCT (D0), and at Days 7, 14, 21, and 28 (D7-28). Samples were drawn into Becton-Dickinson (BD) Vacutainer tubes containing either K₂-EDTA or sodium heparin as anti-coagulants. PB was spun 1200 g for 5 min at 4° C. Recovered EDTA plasma was stored in aliquots in pyrogen-free tubes at −80° C. before use of EDTA plasma for ELISA of sCD14 (R&D Systems), BPI and LBP (HyCult), as well as sMD-2³⁵. IL-6, MCP-1, and RANTES were measured by flow cytometry (DakoCytomation MoFlo instrument) using Cytometric Bead Array (CBA, BD Flex Sets) and Summit v4.0 software. Heparinized plasma was used to measure LPS by kinetic turbidimetric Limulus amoebocyte lysate (LAL) assay (performed by Nelson Laboratories, Salt Lake City, Utah). In brief, samples were diluted 1:10 in 10 mM MgCl₂ solution, then heat-denatured at 70±2° C. for 15±2 minutes. Positive control samples were spiked with LPS (Endosafe) prior to LAL assay, yielding a measure called spike recovery. LAL assay results from samples with spike recovery of <50% or >200% were disregarded, as conferring inhibition or enhancement of LPS detection.

Aliquots of heparinized PB (300 μL) were incubated in sterile Eppendorf tubes with end-over-end rotation at 37° C. for 4 hours (to allow spontaneous TNF-α elaboration) before collection of the extra-cellular medium for measurement of TNF-α by ELISA (R&D Systems). Monocyte surface expression of CD14, TLR2 and TLR4 was measured in heparin-anti-coagulated PB, processed within 2 hrs of collection, by incubating with antigen-specific or isotype control mAbs (BD BioSciences) for 30 min at room temperature, then fixed (BD FACSLyse). Fixed samples were stored at −80° C. until analysis by flow cytometry. Monocytes were gated by high CD14 staining and forward/side-scatter properties. Monocyte surface TLR2 and TLR4 levels were expressed as a Binding Index (BI): (Mean Fluorescence Intensity)*(% Positive cells).

### Statistical Analyses.

Samples with undetectable analytes were assigned a value at half the lower limit of detection. For most assays, a logarithmic transformation yielded distributions that were more approximately normal, thus data were analyzed after logarithmic transformation. Means and confidence intervals were then transformed back to original units and plotted on a logarithmic axis. The Wilcoxon signed rank test for matched pairs was employed when comparing values for the same patients at different time points, with values compared to baseline (B). Unadjusted associations between subjects who developed vs. those who did not develop aGVHD were evaluated using the Mann-Whitney test. Multivariable logistic regression was performed using SAS v9.1 to explore whether the associations found in these unadjusted analyses retained predictive value when considered together in adjusted analysis. When assessing correlations between different parameters, within-subject correlations were calculated using the Spearman correlation coefficient and data from multiple time-points. The calculated coefficients were averaged over the different subjects and significance tested with the signed rank test. Unless otherwise noted, all p-values are two-sided. Results were considered significant at p≦0.05, and indicated as follows: *p≦0.05, **p≦0.01, ***p≦0.001. Statistical significance and graphic output were generated using Prism v. 4.0a (GraphPad Software; San Diego, Calif.).

### REFERENCES

1. Ratanatharathorn V, Ayash L, Lazarus H M, Fu J, Uberti J P. Chronic graft-versus-host disease: clinical manifestation and therapy. Bone Marrow Transplant 2001;28(2):121-9.
2. Vogelsang G B, Lee L, Bensen-Kennedy D M. Pathogenesis and treatment of graft-versus-host disease after bone marrow transplant. Annu Rev Med 2003;54:29-52.
3. Reddy P, Ferrara J L. Immunobiology of acute graft-versus-host disease. Blood Rev 2003;17(4):187-94.
4. Nash R A, Pepe M S, Storb R, et al. Acute graft-versus-host disease: analysis of risk factors after allogeneic marrow transplantation and prophylaxis with cyclosporine and methotrexate. Blood 1992;80(7):1838-45.
5. Locatelli F, De Stefano P. T-cell depletion to prevent GVHD after unrelated-donor marrow transplantation. Lancet 2005;366(9487):692-4.
6. Wagner J E, Thompson J S, Carter S L, Kernan N A. Effect of graft-versus-host disease prophylaxis on 3-year disease-free survival in recipients of unrelated donor bone marrow (T-cell Depletion Trial): a multi-centre, randomised phase II-III trial. Lancet 2005;366(9487):733-41.
7. Chao N J, Chen B J. Prophylaxis and treatment of acute graft-versus-host disease. Semin Hematol 2006;43(1):32-41.
8. Blazar B R, Murphy W J. Bone marrow transplantation and approaches to avoid graft-versus-host disease (GVHD). Philos Trans R Soc Lond B Biol Sci 2005;360(1461):1747-67.
9. Ferrara J L, Cooke K R, Teshima T. The pathophysiology of acute graft-versus-host disease. International Journal of Hematology 2003;78(3):181-7.
10. Cooke K R, Hill G R, Crawford J M, et al. Tumor necrosis factor-alpha production to lipopolysaccharide stimulation by donor cells predicts the severity of experimental acute graft-versus-host disease. J Clin Invest 1998;102(10):1882-91.
11. Cooke K R, Gerbitz A, Crawford J M, et al. LPS antagonism reduces graft-versus-host disease and preserves graft-versus-leukemia activity after experimental bone marrow transplantation. Journal of Clinical Investigation June 2001;107(12):1581-1589.
12. Levy O, Teixeira-Pinto A, White M L, et al. Endotoxemia and elevation of lipopolysaccharide-binding protein after hematopoietic stem cell transplantation. Pediatric Infectious Disease Journal 2003 ;22(11): 978-81.
13. Blijlevens N M, Donnelly J P, DePauw B E. Inflammatory response to mucosal barrier injury after myeloablative therapy in allogeneic stem cell transplant recipients. Bone Marrow Transplant 2005;36(8):703-7.
14. Devetten M P, Vose J M. Graft-versus-host disease: how to translate new insights into new therapeutic strategies. Biol Blood Marrow Transplant 2004;10(12):815-25.
15. Cooke K R, Olkiewicz K, Erickson N, Ferrara J L. The role of endotoxin and the innate immune response in the pathophysiology of acute graft-versus-host disease. Journal of Endotoxin Research 2002;8(6):441-8.
16. Sauer M, Tiede K, Fuchs D, Gruhn B, Berger D, Zintl F. Procalcitonin, C-reactive protein, and endotoxin after bone marrow transplantation: identification of children at high risk of morbidity and mortality from sepsis. Bone Marrow Transplant 2003;31(12):1137-42.
17. Ulevitch R J, Tobias P S. Recognition of gram-negative bacteria and endotoxin by the innate immune system. Current Opinion In Immunology 1999;11(1):19-22.
18. Holler E, Kolb H J, Mittermuller J, et al. Modulation of acute graft-versus-host-disease after allogeneic bone marrow transplantation by tumor necrosis factor alpha (TNF alpha) release in the course of pretransplant conditioning: role of conditioning regimens and prophylactic application of a monoclonal antibody neutralizing human TNF alpha (MAK 195F). Blood 1995;86(3):890-9.
19. Hill G R, Ferrara J L. The primacy of the gastrointestinal tract as a target organ of acute graft-versus-host disease: rationale for the use of cytokine shields in allogeneic bone marrow transplantation. Blood 2000;95(9):2754-9.
20. Cavet J, Middleton P G, Segall M, Noreen H, Davies S M, Dickinson A M. Recipient tumor necrosis factor-alpha and interleukin-10 gene polymorphisms associate with early mortality and acute graft-versus-host disease severity in HLA-matched sibling bone marrow transplants. Blood 1999;94(11):3941-6.
21. Schmaltz C, Alpdogan O, Muriglan S J, et al. Donor T cell-derived TNF is required for graft-versus-host disease and graft-versus-tumor activity after bone marrow transplantation. Blood 2003;101(6):2440-5.
22. Ordemann R, Hutchinson R, Friedman J, et al. Enhanced allostimulatory activity of host antigen-presenting cells in old mice intensifies acute graft-versus-host disease. J Clin Invest 2002;109(9):1249-56.
23. Viriyakosol S, Tobias P S, Kitchens R L, Kirkland T N. MD-2 binds to bacterial lipopolysaccharide. Journal of Biological Chemistry. 2001 ;276(41):38044-51.
24. Gioannini T L, Teghanemt A, Zhang D, Levis E N, Weiss J P. Monomeric endotoxin:protein complexes are essential for TLR4-dependent cell activation. J Endotoxin Res 2005;11(2):117-23.
25. Prohinar P, Re F, Widstrom R, et al. Specific high affinity interactions of monomeric endotoxin.protein complexes with Toll-like receptor 4 ectodomain. J Biol Chem 2007;282(2):1010-7.
26. Kitchens R L, Thompson P A. Modulatory effects of sCD14 and LBP on LPS-host cell interactions. J Endotoxin Res 2005;11(4):225-9.
27. Levels J H, Marquart J A, Abraham P R, et al. Lipopolysaccharide is transferred from high-density to low-density lipoproteins by lipopolysaccharide-binding protein and phospholipid transfer protein. Infect Immun 2005;73(4):2321-6.
28. Fenton M J, Golenbock D T. LPS-binding proteins and receptors. Journal of Leukocyte Biology 1998;64(1):25-32.
29. Levy O. A neutrophil-derived anti-infective molecule: bactericidal/permeability-increasing protein. Antimicrobial Agents & Chemotherapy 2000;44:2925-2931.
30. Levy O. Antimicrobial proteins and peptides: Anti-infective molecules of mammalian leukocytes. J Leuk Biol 2004;76:909-925.
31. Shahrara S, Park C C, Temkin V, Jarvis J W, Volin M V, Pope R M. RANTES modulates TLR4-induced cytokine secretion in human peripheral blood monocytes. J Immunol 2006;177(8):5077-87.
32. Abrahams V M, Visintin I, Aldo P B, Guller S, Romero R, Mor G. A role for TLRs in the regulation of immune cell migration by first trimester trophoblast cells. J Immunol 2005;175(12):8096-104.
33. Zisman D A, Kunkel S L, Strieter R M, et al. MCP-1 protects mice in lethal endotoxemia. J Clin Invest 1997;99(12):2832-6.
34. Przepiorka D, Weisdorf D, Martin P, et al. 1994 Consensus Conference on Acute GVHD Grading. Bone Marrow Transplantation. 1995;15(6):825-8.
35. Viriyakosol S, McCray P, Ashbaugh M A, et al. Characterization of monoclonal antibodies to human soluble MD-2. Hybridoma 2006:in press.
36. Bazil V, Strominger J L. Shedding as a mechanism of down-modulation of CD14 on stimulated human monocytes. Journal of Immunology. 1991;147(5):1567-74.
37. Marsik C, Mayr F, Cardona F, Derhaschnig U, Wagner O F, Jilma B. Endotoxaemia modulates Toll-like receptors on leucocytes in humans. British Journal of Haematology 2003;121:653-6.
38. Holler E, Kolb H J, Hintermeier-Knabe R, et al. Role of tumor necrosis factor alpha in acute graft-versus-host disease and complications following allogeneic bone marrow transplantation. Transplant Proc 1993;25(1 Pt 2):1234-6.
39. Fowler D H, Foley J, Whit-Shan Hou J, et al. Clinical “cytokine storm” as revealed by monocyte intracellular flow cytometry: correlation of tumor necrosis factor alpha with severe gut graft-versus-host disease. Clin Gastroenterol Hepatol 2004;2(3):237-45.
40. von Hundelshausen P, Petersen F, Brandt E. Platelet-derived chemokines in vascular biology. Thromb Haemost 2007 ;97(5):704-13.
41. Tang Y Q, Yeaman M R, Selsted M E. Antimicrobial peptides from human platelets. Infect Immun 2002;70(12):6524-33.
42. Carrol E D, Thomson A P, Mobbs K J, Hart C A. The role of RANTES in meningococcal disease. J Infect Dis 2000;182(1):363-6.
43. Giroir B P. Meningococcemia as a model for testing the hypothesis of antisepsis therapies. Crit Care Med 2000;28(9 Suppl):557-9.
44. Couriel D, Saliba R, Hicks K, et al. Tumor necrosis factor-alpha blockade for the treatment of acute GVHD. Blood 2004;104(3):649-54.
45. Bongartz T, Sutton A J, Sweeting M J, Buchan I, Matteson E L, Montori V. Anti-TNF antibody therapy in rheumatoid arthritis and the risk of serious infections and malignancies: systematic review and meta-analysis of rare harmful effects in randomized controlled trials. Jama 2006;295(19):2275-85.
46. Abdul-Hai A, Weiss L, Slavin S, Or R. Improved survival following induction of GVHD following lipopolysaccharide immunization. Exp Hematol 2006;34(4):549-53.
47. Levy O. Therapeutic potential of the bactericidal/permeability-increasing protein. Expert Opinion in Investigational Drugs 2002;11:159-167.
48. Lynn M, Rossignol D P, Wheeler J L, et al. Blocking of responses to endotoxin by E5564 in healthy volunteers with experimental endotoxemia. Journal of Infectious Diseases. 2003;187(4):631-9.
49. von der Mohlen M, van Deventer, S, Levi, M, et al. Inhibition of endotoxin-induced cytokine release and neutrophil activation in humans by use of recombinant bactericidal/permeability-increasing protein. J. Infect. Dis 1995;172:144-151.
50. von der Mohlen M, van Deventer S, Levi M, et al. Inhibition of endotoxin-induced activation of the coagulation and fibrinolytic pathways using a recombinant endotoxin-binding protien (rBPI23). Blood 1995;85:3437-3443.
51. Levin M, Quint P A, Goldstein B, et al. Recombinant bactericidal/permeability-increasing protein (rBPI21) as adjunctive treatment for children with severe meningococcal sepsis: a randomised trial. rBPI21 Meningococcal Sepsis Study Group.[see comment]. Lancet 2000;356(9234):961-7.

1. A method for determining the likelihood of a subject to develop acute graft versus host disease (aGVHD) upon receiving myeloablative allogeneic hematopoietic stem cell transplantation (HSCT), comprising:
a) assaying for baseline plasma concentration of RANTES in a sample obtained from the subject; and
b) comparing the baseline plasma concentration of RANTES to a predetermined level;
wherein a baseline plasma concentration of RANTES less than the predetermined level indicates a likelihood of the subject to develop aGVHD upon receiving myeloablative allogeneic HSCT.

2. The method of claim 1 wherein the predetermined level is about 20,000 pg/ml plasma.

3. The method of claim 2 further comprising:
a) assaying for day 7 plasma concentration of RANTES in a sample obtained from the subject; and
b) comparing the day 7 plasma concentration of RANTES to a predetermined level;
wherein a day 7 plasma concentration of RANTES less than the predetermined level indicates a likelihood of the subject to develop aGVHD upon receiving HSCT.

4. A method for determining the likelihood of a subject to develop acute graft versus host disease (aGVHD) upon receiving myeloablative allogeneic hematopoietic stem cell transplantation (HSCT), comprising:
a) assaying for day 7 plasma concentration of RANTES in a sample obtained from the subject; and
b) comparing the day 7 plasma concentration of RANTES to a predetermined level;
wherein a day 7 plasma concentration of RANTES less than the predetermined level indicates a likelihood of the subject to develop aGVHD upon receiving myeloablative allogeneic HSCT.

5. The method of claim 4 wherein the plasma concentration of RANTES is determined by flow cytometry.

6. The method of claim 4 wherein the predetermined levels that the day 7 plasma concentration of RANTES is compared to is about 2,000 pg/ml plasma.

7. A method for determining the likelihood of a subject to develop acute graft versus host disease (aGVHD) upon receiving myeloablative allogeneic hematopoietic stem cell transplantation (HSCT), comprising:
a) assaying for donor plasma concentration of RANTES in a sample obtained from a donor of the hemtopoietic stem cells; and
b) comparing the donor plasma concentration of RANTES determined in step a) to a predetermined level;
wherein a donor plasma concentration of RANTES less than the predetermined level indicates a likelihood of the subject to develop aGVHD upon receiving myeloablative allogeneic HSCT from that donor.

8. The method of claim 7 wherein predetermined levels is about 60,000 pg/ml plasma.

9. A method for determining the likelihood of a subject to develop acute graft versus host disease (aGVHD) upon receiving myeloablative allogeneic hematopoietic stem cell transplantation (HSCT), comprising:
a) assaying for day 0 plasma concentration of MCP-1 in a sample obtained from the subject; and
b) comparing the day 0 plasma concentration of MCP-1 to a predetermined level;
wherein a day 0 plasma concentration of MCP-1 less than the predetermined level indicates a likelihood of the subject to develop aGVHD upon receiving HSCT.

10. The method of claim 9 wherein the predetermined level is about 400 pg/ml plasma.

11. The method of claim 10 further comprising determining the day 7 plasma concentration of MCP-1 of the subject, wherein a low day 7 plasma concentration of MCP-1 indicates an increased likelihood of the subject developing aGVHD upon receiving HSCT.

12. A method for determining the likelihood of a subject to develop acute graft versus host disease (aGVHD) upon receiving myeloablative allogeneic hematopoietic stem cell transplantation (HSCT), comprising:
a) assaying for day 7 plasma concentration of MCP-1 in a sample obtained from the subject; and
b) comparing the day 7 plasma concentration of MCP-1 to a predetermined level;
wherein a day 7 plasma concentration of MCP-1 less than the predetermined level indicates a likelihood of the subject to develop aGVHD upon receiving HSCT.

13. The method of claim 12 wherein the plasma concentration of MCP-1 is determined by flow cytometry.

14. The method of claim 12 wherein the predetermined level to which the day 7 plasma concentration of MCP-1 is compared is about 700 pg/ml plasma.

15. A method for determining the likelihood of a subject to develop an inflammatory response comprising,
a) assaying for plasma concentration of MCP-1 and/or RANTES in a sample obtained from the subject; and
b) comparing the plasma concentration MCP-1 and/or RANTES to a predetermined level;
wherein a plasma concentration of MCP-1 and/or RANTES less than the predetermined level indicates a likelihood of a subject to develop an inflammatory response.

16. The method of claim 15, wherein subject identified as having a likelihood to develop an inflammatory response is treated prophylactically with one or more anti-inflammatory agents.

17. The method of claim 1 wherein the plasma concentration of RANTES is determined by flow cytometry.

18. The method of claim 10 wherein the plasma concentration of MCP-1 is determined by flow cytometry.
